(19) United States
(12) Patent Application Publication
(10) Pub. No.: US 2019/0156261 A1
(43) Pub. Date: May 23, 2019

(54) FACILITY OPERATION SUPPORT DEVICE, USER TERMINAL DEVICE, AND FACILITY OPERATION SUPPORT METHOD

(71) Applicant: PANASONIC INTELLECTUAL PROPERTY MANAGEMENT CO. LTD., Osaka (JP)

(72) Inventors: Kouhei NISHINO, Tokyo (JP); Tetsurou KAKIZAWA, Kanagawa (JP)

(73) Assignee: PANASONIC INTELLECTUAL PROPERTY MANAGEMENT CO. LTD., Osaka (JP)

(21) Appl. No.: 16/316,673

(22) PCT Filed: Jul. 6, 2017
(86) PCT No.: PCT/JP2017/024770

§ 371 Date: Jan. 10, 2019

(30) Foreign Application Priority Data
Jul. 11, 2016 (JP) 2016-137039
Jul. 11, 2016 (JP) 2016-137041
Jul. 11, 2016 (JP) 2016-137072

(51) Int. Cl. G06Q 10/06; G06K 9/00

(52) U.S. Cl. CPC G06Q 10/06315; G06K 9/00771; G06Q 10/06393

(57) ABSTRACT

It is possible to reasonably perform a task for improving the store operation by presenting information required for improving a store operation to a user. A camera which is a facility capturing device provided for each of a plurality of stores as facilities, a recording server, a management server, and a transmission server, and a user terminal are provided. The recording server, the management server, and the transmission server constitute a cloud computer system. The transmission server transmits information regarding an evaluation result of each policy in the store and an area image corresponding to an attention point on a calendar, to the user terminal. The management server acquires instruction information and report information regarding a work in the store and the evaluation information from the transmission server, and manages status information regarding a progress status for a work instruction.

### TECHNICAL FIELD

The disclosure relates to a facility operation support device, a user terminal device, and a facility operation support method for supporting a task of a user who operates a facility providing products to a user.

### BACKGROUND ART

In stores such as convenience stores, if there is a problem in a display state of commodities displayed on a display stand, that is, the display of the commodities is disturbed, or the commodity is short, opportunity loss occurs, and the opportunity loss has a great influence on store sales. Thus, in a case where there is a problem in a display state of commodities, it is necessary to rapidly perform a commodity management work (tidy-up work and replenishment work) for solving the problem.

In the related art, a technology of determining necessity of a commodity management work based on an image obtained by capturing a display area and performing a report for an instruction of the commodity tidy-up work is known as a technology relating to such a commodity management work (see PTLs 1 and 2). In particular, in the technology disclosed in PTL 1, a reference display pattern is set based on a desirable display state of commodities. The reference display pattern and an actual display state of the commodities are compared to each other, so as to evaluate the display state of the commodities based on similarity between the reference display pattern and the actual display state. In the technology disclosed in PTL 2, a representative figure interpolated between a boundary line defining the outer edge of a commodity presence area and a boundary line of a commodity absence area inside the commodity presence area is obtained. The degree of appropriateness (face-up degree) of the display state of commodities is calculated based on the area of the representative figure.

In a store operation system, for example, a convenience store, which includes multiple stores are provided, a supervisor belonging to the headquarter that collectively controls each store grasps the situation of the store and gives guidance and suggestions to the store manager while visiting the stores. However, in recent years, the number of stores handled by one supervisor increases, and the situation of each store varies. Thus, a technology in which a supervisor can perform a task of operating stores with high efficiency is desired. In addition, one owner may operate multiple stores. Similar to the supervisor, even in a case of such an owner, improvement of efficiency of a store operation task is desired.

In the related art, a technology as follows is known as a technology relating to such a store operation task performed by a supervisor or an owner operating many stores. That is, internal and external situations in a plurality of stores such as franchisees in a franchise chain (FC) are remotely surveilled by a surveillance camera and a microphone. Various kinds of information which have been created based on image data from the surveillance camera and sound data from the microphone and are required for operating the store are provided, as operation guidance information, to the headquarter such as FC headquarters in online (see PTL 3).

In addition, a technology as follows is known. Any sales floor is selected from a plurality of sales floors, a list of images of the sales floor and sales data of commodities for each time slot on date and time which have been set are displayed, and thus it is possible to grasp the actual situation of the sales floor and the trend of sales for each time slot (see PTL 4).

In addition, in a store operation system, for example, a convenience store, which includes multiple stores are provided, a supervisor belonging to the headquarter that collectively controls each store grasps the situation of the store and gives guidance and suggestions to the store manager while visiting the stores. However, in recent years, the number of stores managed by one supervisor increases, and the situation of each store varies. Thus, a technology in which a supervisor can perform a task of operating stores with high efficiency is desired. In addition, one owner may operate multiple stores. Similar to the supervisor, even in a case of such an owner, improvement of efficiency of a store operation task is desired.

In the related art, a technology as follows is known as a technology relating to such a store operation task performed by a supervisor or an owner operating many stores. That is, internal and external situations in a plurality of stores such as franchisees in a franchise chain (FC) are remotely surveilled by a surveillance camera and a microphone. Various kinds of information which have been created based on image data from the surveillance camera and sound data from the microphone and are required for operating the store are provided, as operation guidance information, to the headquarter such as FC headquarters in online (see PTL 3).

In addition, a technology as follows is known. A person in charge regularly visits a retail store. The sales floor configurations before and after an inspection or correction work are imaged by digital image capturing means, and the obtained image data is transmitted to information processing means installed in a store front support headquarter through a mobile computing tool, along with predetermined item data. In the store front support headquarter, a sales-floor situation report with the images of the sales floor configuration before and after the inspection or correction work is created based on reception data, and thus the sales-floor situation report is caused to be useful for the next store front support (see PTL 5).

### CITATION LIST

### Patent Literature

PTL 1: Japanese Patent No. 3908047

PTL 2: Japanese Patent No. 4473676

PTL 3: Japanese Patent Unexamined Publication No. 2002-366621

PTL 4: Japanese Patent No. 5072985

PTL 5: Japanese Patent Unexamined Publication No. 2001-306786

### SUMMARY OF THE INVENTION

However, in the technologies in the related art, the inappropriate display state of commodities is comprehensively determined with including both a state where the display of the commodities is disturbed and a state where the commodity is short. Thus, it is possible that a user grasps necessity of a work for improving the inappropriate display state of the commodities. However, there is a problem in that it is not possible to grasp a specific required work.

For example, in a time slot just before commodities are brought into a store, since the store has a small stock, it is not possible to sufficiently perform a commodity replenishment work, but it is possible to perform a commodity tidy-up work. Although the commodity tidy-up work, for example, a work of increasing the volume degree, the alignment degree, or the face-up degree is desired, in the technology in the related art, there is a problem in that it is not possible that the user grasps such a specific work.

An object of the disclosure is to provide a facility operation support device, a user terminal device, and a facility operation support method in which it is possible to present information which allows a work required for improving a store operation to be immediately grasped based on an image obtained by capturing the inside of a store, to a user, and it is possible to reasonably perform a task for improving the store operation.

According to the disclosure, a facility operation support device supports a task of a user who operates a facility providing a product to a user. The facility operation support device includes a policy setting unit that sets at least one policy in which an evaluation condition which includes an attention area and a display index in the facility and is used when a display state of a product is evaluated has been defined, an image acquisition unit that acquires a captured image obtained by capturing the attention area, a product detector that acquires product detection information indicating a position of a product in the attention area based on the captured image, a policy evaluation unit that calculates an evaluation index corresponding to the display index, based on the product detection information, and evaluates an achievement situation of the policy based on the evaluation index, and an evaluation information presentation unit that presents information regarding an evaluation result of each policy, which has been acquired by the policy evaluation unit, to the user.

According to the disclosure, a user terminal device displays a screen transmitted from a facility operation support device that supports a task of a user who operates a facility providing a product to a user. The user terminal device displays a screen for causing the user to designate at least one policy in which an evaluation condition which includes an attention area and a display index in the facility and is used when a display state of a product is evaluated has been defined, and displays a screen for presenting information regarding a result obtained by evaluating an achievement situation of each policy based on the evaluation condition, to the user.

According to the disclosure, a facility operation support method causes an information processing apparatus to support a task of a user who operates a facility providing a product to a user. The facility operation support method includes setting at least one policy in which an evaluation condition which includes an attention area and a display index in the facility and is used when a display state of a product is evaluated has been defined, acquiring a captured image obtained by capturing the attention area, acquiring product detection information indicating a position of a product in the attention area, based on the captured image, calculating an evaluation index corresponding to the display index, based on the product detection information, and evaluating an achievement situation of the policy based on the evaluation index, and presenting information regarding an obtained evaluation result of each policy to the user.

According to the disclosure, the evaluation result regarding the achievement situation of each policy in which the attention area and the display index have been defined is presented to the user. Thus, it is possible to immediately grasp a work required for improving a store operation, and to reasonably perform a task for improving the store operation.

According to the technology disclosed in PTL 3, operation guidance information (salesclerk information, commodity display information, merchandise shortage information, product stock information, visitor information, and the like) required for guiding an operation of the store can be acquired from a remote place in which an FC headquarter or the like of, for example, a convenience store. Thus, it is possible to significantly reduce a burden on a supervisor. As disclosed in PTL 4, it is possible to recognize a situation of a sales floor in each time slot without going to the sales floor one by one, by incorporating a live camera capable of acquiring an image of each sales floor into a POS system.

In the technologies in the related art, convenience in that it is possible to monitor a situation of a sales floor or the like in a remote place is obtained. However, there is a problem as follows. That is, a mechanism in which a plurality of users such as supervisors, owners, or store managers who operate many stores recognizes operation situations of the stores with high efficiency even in a case where the number of stores or the number of sales floors increases is not considered at all, and it is not possible to reasonably perform a task for improving a store operation.

An object of the disclosure is to provide a facility operation support device, a user terminal device, and a facility operation support method in which it is possible that a plurality of users such as a manager who manages a plurality of facilities and a manager for each facility recognizes an operation situation of a facility with high efficiency and reasonably performs a task for improving a facility operation, even in a case where the number of facilities or the number of target areas in a facility increases.

According to the disclosure, a facility operation support device supports a task of a user who operates a facility providing a product or a service to a user. The facility operation support device includes an image accumulation unit that accumulates a plurality of area images obtained by capturing a target area in the facility, an accounting information acquisition unit that acquires accounting information regarding providing of the product or the service to the user, an evaluation unit that acquires an actual value and an expected value of each day in a target period based on the accounting information, compares the actual value and the expected value of each day to each other, evaluates a record for an operation situation of the facility for each day, and acquires a date as an attention point based on the evaluation result, an image acquisition unit that acquires the area image corresponding to the attention point from the plurality of area images accumulated in the image accumulation unit, and a display information generation unit that generates display information including a calendar of the target period, on which the attention point has been shown and outputs display information including the area image corresponding to the attention point in accordance with an operation of the user selecting the attention point.

According to the disclosure, a user terminal device displays a screen transmitted from a facility operation support device that supports a task of a user who operates a facility providing a product or a service to a user. The user terminal device presents a calendar of a target period, in which a date as an attention point acquired by evaluating a record for an operation situation of a facility on each date in the target period is shown, based on accounting information for providing a product or a service to a user, and displays a screen for causing the user to select the attention point, and displays a screen for presenting an area image in the facility corresponding to the attention point, to the user in accordance with an operation of the user who selects the attention point.

According to the disclosure, a facility operation support method causes an information processing apparatus to support a task of a user who operates a facility providing a product or a service to a user. The facility operation support method includes accumulating a plurality of area image obtained by capturing a target area in the facility, acquiring accounting information for providing the product or the service to the user, acquiring an actual value and an expected value on each date in a target period based on the accounting information, comparing the actual value and the expected value on each date to each other, evaluating a record for an operation situation of the facility on each date, and acquiring a date as an attention point based on the evaluation result, acquiring the area image corresponding to the attention point from a plurality of accumulated area images, and generating display information including a calendar of the target period, which the attention point has been shown, and outputting display information including the area image corresponding to the attention point, in accordance with an operation of the user who selects the attention point.

According to the disclosure, the date as the attention point acquired by evaluating the operation situation of the facility is displayed on the calendar. Thus, it is possible that the user immediately determines a point to attract attentions for improving a facility operation. Since the area image corresponding to the attention point is displayed by selecting the attention point, it is possible to simply grasp the actual situation in the target area. Thus, it is possible that a plurality of users such as a manager who manages a plurality of facilities and a manager for each facility recognizes an operation situation of a facility with high efficiency and reasonably performs a task for improving a facility operation, even in a case where the number of facilities or the number of target areas in a facility increases.

According to the technology disclosed in PTL 3, operation guidance information (salesclerk information, commodity display information, merchandise shortage information, product stock information, visitor information, and the like) required for guiding an operation of the store can be acquired from a remote place in which an FC headquarter or the like of, for example, a convenience store. Thus, it is possible to significantly reduce a burden on a supervisor. According to the technology disclosed in PTL 5, a person visiting a store can create a sales-floor situation report having a form of comparing captured images for sales floor configurations before and after being inspected or corrected for the situation in the sales floor, in the information processing apparatus in the headquarter.

Meanwhile, in a case where multiple stores are instructed of required works relating to a sale (special sale), a campaign, or the like in which a priority commodity, a new commodity, or the like is set as a target, it is desirable that information transmitted and received when an instruction of a work for a facility (for example, an instruction of the work, a report in response to the instruction, and an evaluation for the report) has been performed is collected with high efficiency, and the progress status of the work of which the instruction has been performed is appropriately managed. However, in the technology in the related art, there are problems in that such a desire is not considered at all, and it is not possible to appropriately collect and manage the required information with high efficiency.

In addition, if it is assumed that required information can be shared between a plurality of users, it is possible to promote communications between the plurality of users and to reasonably perform a store operation task. However, in the technology in the related art, information flows unidirectionally, that is, information regarding a status of commodities in a store or a situation of a salesclerk is provided to a supervisor in the headquarter in one direction. Thus, there are problems in that a mechanism of sharing information between a plurality of users such as a supervisor and a store manager is not considered at all, and it is not possible to perform sufficient communications between the plurality of users, and thus it is not possible to reasonably perform a store operation task.

An object of the disclosure is to provide a facility operation support device, a user terminal device, and a facility operation support method in which it is possible to collect information transmitted and received when an instruction of a work for a facility (for example, an instruction of the work, a report in response to the instruction, and an evaluation for the report) has been performed, with high efficiency and to appropriately manage a progress status of a task relating to the instruction, and it is also possible to share information between a plurality of users and to reasonably perform a facility operation task.

According to the disclosure, a facility operation support device supports tasks of a first user and a second user who operate a facility providing a product or a service to a user. The facility operation support device includes a transmission unit that transmits an input screen to a first user terminal device operated by the first user who performs an instruction for a work in the facility and a second user terminal device operated by the second user who performs the work of which the instruction has been performed, and a management unit that manages information acquired on the input screen. The transmission unit transmits a first input screen for causing the first user to input instruction information regarding contents of the instruction to the first user terminal device and acquires the instruction information, transmits a second input screen for causing the second user to input report information regarding a result obtained by performing the work of which the instruction has been performed, to the second user terminal device and acquires the report information, with presenting the instruction information to the second user, and transmits a third input screen for causing the first user to input evaluation information regarding an evaluation result for a situation of performing the work of which the instruction has been performed, to the first user terminal device and acquires the evaluation information, with presenting the report information to the first user. The management unit acquires the instruction information, the report information, and the evaluation information from the transmission unit and manages status information regarding a progress status of a task relating to the instruction.

According to the disclosure, a user terminal device displays a screen transmitted from a facility operation support device that supports tasks of a first user and a second user who operate a facility providing a product or a service to a user. The user terminal device is operated by the first user who performs an instruction for a work in the facility, displays an input screen of causing the first user to input instruction information regarding contents of the instruction, transmits the instruction information to a server apparatus, presents report information regarding a result obtained by the second user performing the work based on the instruction information, to the first user, displays an input screen for causing the first user to input evaluation information regarding an evaluation result for a situation of performing the work of which the instruction has been performed, and transmits the evaluation information to the server apparatus.

According to the disclosure, a user terminal device displays a screen transmitted from a facility operation support device that supports tasks of a first user and a second user who operate a facility providing a product or a service to a user. The user terminal device is operated by the second user who performs a work by an instruction from the first user, presents instruction information regarding contents of the instruction to the second user, displays an input screen for causing the second user to input report information regarding a result obtained by performing the work of which the instruction has been performed, transmits the report information to a server apparatus, presents evaluation information regarding an evaluation result which has been obtained by the first user evaluating a situation of performing the work based on the report information, to the second user, and displays a browsing screen for urging re-performing of the work in a case where the work of which the instruction has been performed is not appropriately performed.

According to the disclosure, a facility operation support method causes an information processing apparatus to support tasks of a first user and a second user who operate a facility providing a product or a service to a user. The facility operation support method includes transmitting a first input screen for causing the first user who performs an instruction for a work in the facility to input instruction information regarding contents of the instruction, to a first user terminal device operated by the first user, presenting the instruction information to the second user who performs a work of which the instruction has been performed, and transmitting a second input screen for causing the second user to input report information regarding a result obtained by performing the work of which the instruction has been performed, to a second user terminal device operated by the second user, presenting the report information to the first user and transmitting a third input screen for causing the first user to input evaluation information regarding an evaluation result for a situation of performing the work of which the instruction has been performed, to the first user terminal device, and managing status information regarding a progress status of a task relating to the instruction, based on the instruction information, the report information, and the evaluation information.

According to the disclosure, it is possible to collect information transmitted and received when an instruction of a work for a facility, that is, information regarding contents of the instruction, information regarding a report in response to the instruction, and information regarding an evaluation for the report with high efficiency, and to appropriately manage a progress status of a task relating to an instruction.

### BRIEF DESCRIPTION OF DRAWINGS

FIG. 1 is a diagram illustrating an overall configuration of a facility operation support system according to an exemplary embodiment.

FIG. 2 is a plan view of a store illustrating a layout of the store and an installation situation of camera 1.

FIG. 3 is a block diagram illustrating a hardware configuration of camera 1, recording server 3, management server 4, transmission server 5, and user terminal 6.

FIG. 4 is a functional block diagram illustrating management server 4.

FIG. 5 is a diagram illustrating a log-in screen displayed in user terminal 6.

FIG. 6 is a diagram illustrating a display report screen displayed in user terminal 6.

FIG. 7 is a diagram specifically illustrating an area image displayed in area image display portion 116 of the display report screen.

FIG. 8 is a diagram illustrating a display report setting screen displayed in user terminal 6.

FIG. 9 is a diagram illustrating a selection menu displayed on the display report setting screen.

FIG. 10 is a diagram illustrating a store comparison screen displayed in user terminal 6.

FIG. 11 is a diagram illustrating a sales-floor list screen displayed in user terminal 6.

FIG. 12 is a diagram illustrating a designated-time screen displayed in user terminal 6.

FIG. 13 is a diagram illustrating a whole-day checking screen displayed in user terminal 6.

FIG. 14 is a functional block diagram illustrating management server 4.

FIG. 15 is a diagram illustrating the log-in screen displayed in user terminal 6.

FIG. 16 is a diagram illustrating a monthly graph analysis screen displayed in user terminal 6.

FIG. 17 is a diagram illustrating a selection menu for an analysis condition on a monthly analysis screen.

FIG. 18 is a diagram illustrating a daily graph analysis screen displayed in user terminal 6.

FIG. 19 is a diagram illustrating a selection menu for a comparison target on a daily analysis screen.

FIG. 20 is a diagram illustrating the daily graph analysis screen when item addition has been selected.

FIG. 21 is a diagram illustrating a POS carrying-in screen displayed in user terminal 6.

FIG. 22 is a diagram illustrating the store comparison screen displayed in user terminal 6.

FIG. 23 is a diagram illustrating the sales-floor list screen displayed in user terminal 6.

FIG. 24 is a diagram illustrating the designated-time screen displayed in user terminal 6.

FIG. 25 is a diagram illustrating the whole-day checking screen displayed in user terminal 6.

FIG. 26 is a diagram illustrating a monitoring screen as a transition destination when a button 127 of “monitoring” has been operated on the daily graph analysis screen.

FIG. 27 is a sequence chart illustrating an overall flow of a weekly instruction and a weekly report.

FIG. 28 is a diagram illustrating a weekly-instruction addition screen viewed and operated by a manager.

FIG. 29 is a diagram illustrating a weekly-report list screen viewed and operated by a store manager.

FIG. 30 is a diagram illustrating a weekly-report detail screen viewed and operated by the store manager.

FIG. 31 is a diagram illustrating the weekly-report list screen viewed and operated by the manager.

FIG. 32 is a diagram illustrating the weekly-report detail screen viewed and operated by the manager.

FIG. 33 is a diagram illustrating the weekly-report list screen displayed in a smartphone.

FIG. 34 is a diagram illustrating the weekly-report detail screen displayed in the smartphone.

### DESCRIPTION OF EMBODIMENT

To solve the above problem, according to a first aspect of the invention, a facility operation support device supports a task of a user who operates a facility providing a product to a user. The facility operation support device includes a policy setting unit that sets at least one policy in which an evaluation condition which includes an attention area and a display index in the facility and is used when a display state of a product is evaluated has been defined, an image acquisition unit that acquires a captured image obtained by capturing the attention area, a product detector that acquires product detection information indicating a position of a product in the attention area based on the captured image, a policy evaluation unit that calculates an evaluation index corresponding to the display index, based on the product detection information, and evaluates an achievement situation of the policy based on the evaluation index, and an evaluation information presentation unit that presents information regarding an evaluation result of each policy, which has been acquired by the policy evaluation unit, to the user.

According to this configuration, the evaluation result regarding the achievement situation of each policy in which the attention area and the display index have been defined is presented to the user. Thus, it is possible to immediately grasp a work required for improving a store operation, and to reasonably perform a task for improving the store operation.

According to a second aspect of the invention, the display index is any one of a display quantity, a face-up degree, an alignment degree, a volume degree, and a stockout continuity degree. The display quantity indicates a degree of occupation of products in an area in which the products are displayed. The face-up degree indicates a degree of displaying products side by side at a frontmost position. The alignment degree indicates a degree of aligning and displaying products in a left-right direction. The volume degree indicates a degree of collectively displaying a large amount of products. The stockout continuity degree indicates a degree of a length of a duration of a stockout state in which a product is short.

According to this configuration, it is possible to set various policies.

According to a third aspect of the invention, an evaluation result integration unit that integrates the evaluation result of each policy acquired by the policy evaluation unit, in a unit of the facility, and acquires an evaluation score as the evaluation result in the unit of the facility is further provided. The evaluation information presentation unit presents the evaluation score relating to the facility attracting attentions to the user.

According to this configuration, it is possible that the user immediately grasps the achievement situation of the policy in a unit of a facility.

According to a fourth aspect of the invention, the policy evaluation unit evaluates the achievement situation of the policy for each predetermined unit time, and the evaluation information presentation unit presents digest information indicating a list of an evaluation result of the policy for each unit time, to the user.

According to this configuration, it is possible that the user immediately grasps the achievement situation of the policy for each unit time (for example, one day).

According to a fifth aspect of the invention, the evaluation information presentation unit presents the captured image obtained by capturing the attention area of each policy corresponding to the evaluation result, to the user along with the evaluation result of each policy.

According to this configuration, the area image of the attention area of each policy is presented to the user. Thus, it is possible that the user checks the actual situation in the attention area in detail.

According to a sixth aspect of the invention, the evaluation information presentation unit presents display information in which a frame image showing a range of the attention area is superimposed on the captured image obtained by capturing the attention area, to the user.

According to this configuration, it is possible that the user immediately grasps the attention area set as a target by the policy on the captured image.

According to a seventh aspect of the invention, the policy setting unit sets the policy in which an evaluation time point has been defined as the evaluation condition, and the policy evaluation unit evaluates the achievement situation of the policy at the evaluation time point.

According to this configuration, it is possible to evaluate the achievement situation of the policy at a time point considered as important on an operation of the facility.

According to an eighth aspect of the invention, the policy setting unit sets the policy in which an evaluation criterion has been defined as the evaluation condition, and the policy evaluation unit evaluates the achievement situation of the policy based on the evaluation criterion.

According to this configuration, it is possible to appropriately determine whether the policy is achieved to a necessary and sufficient degree, by defining the evaluation criterion (for example, threshold) for each policy.

According to a ninth aspect of the invention, the policy setting unit sets the policy in which the evaluation condition has been defined, in accordance with an operation input of the user.

According to this configuration, it is possible that the user freely designates the evaluation condition (for example, the attention area and the display index) of the policy.

According to a tenth aspect of the invention, a user terminal device displays a screen transmitted from a facility operation support device that supports a task of a user who operates a facility providing a product to a user. The user terminal device displays a screen for causing the user to designate at least one policy in which an evaluation condition which includes an attention area and a display index in the facility and is used when a display state of a product is evaluated has been defined, by the user, and displays a screen for presenting information regarding a result obtained by evaluating an achievement situation of each policy based on the evaluation condition, to the user.

According to this configuration, similar to the first aspect of the invention, it is possible to present information which allows a work required for improving a store operation to be immediately grasped, to the user. It is possible to reasonably perform a task for improving the store operation.

According to an eleventh aspect of the invention, a facility operation support method causes an information processing apparatus to support a task of a user who operates a facility providing a product to a user. The facility operation support method includes setting at least one policy in which an evaluation condition which includes an attention area and a display index in the facility and is used when a display state of a product is evaluated has been defined, acquiring a captured image obtained by capturing the attention area, acquiring product detection information indicating a position of a product in the attention area, based on the captured image, calculating an evaluation index corresponding to the display index, based on the product detection information, and evaluating an achievement situation of the policy based on the evaluation index, and presenting information regarding an obtained evaluation result of each policy to the user.

According to this configuration, similar to the first aspect of the invention, it is possible to present information which allows a work required for improving a store operation to be immediately grasped, to the user. It is possible to reasonably perform a task for improving the store operation.

According to a twelfth aspect of the invention, a facility operation support device supports a task of a user who operates a facility providing a product or a service to a user. The facility operation support device includes an image accumulation unit that accumulates a plurality of area images obtained by capturing a target area in the facility, an accounting information acquisition unit that acquires accounting information regarding providing of the product or the service to the user, an evaluation unit that acquires an actual value and an expected value of each day in a target period based on the accounting information, compares the actual value and the expected value of each day to each other, evaluates a record for an operation situation of the facility for each day, and acquires a date as an attention point based on the evaluation result, an image acquisition unit that acquires the area image corresponding to the attention point from the plurality of area images accumulated in the image accumulation unit, and a display information generation unit that generates display information including a calendar of the target period, on which the attention point has been shown and outputs display information including the area image corresponding to the attention point in accordance with an operation of the user selecting the attention point.

According to this configuration, since the date as the attention point acquired by evaluating the operation situation of the facility is displayed on the calendar, it is possible that the user immediately determines a point to attract attentions for improving a facility operation. Since the area image corresponding to the attention point is displayed by selecting the attention point, it is possible to simply grasp the actual situation in the target area. Thus, it is possible that a plurality of users such as a manager who manages a plurality of facilities and a manager for each facility recognizes an operation situation of a facility with high efficiency and reasonably performs a task for improving a facility operation, even in a case where the number of facilities or the number of target areas in a facility increases.

According to a thirteenth aspect of the invention, the image accumulation unit regularly acquires and accumulates the area image obtained by capturing the target area for each of a plurality of facilities.

According to this configuration, it is possible to simply acquire the area image corresponding to the attention point.

According to a fourteenth aspect of the invention, the accounting information acquisition unit acquires at least one of a sales amount, a payment amount per one user, the number of payers, and a proportion of a sales amount of each type of used product or service, as the accounting information.

According to this configuration, it is possible to acquire the attention point from various viewpoints.

According to a fifteenth aspect of the invention, the expected-value setting unit sets at least one of a planned value of each facility, the actual value of each facility, an average value of the actual value for each of all the facilities, and an average value of the actual value on a plurality of designated dates in a predetermined period, as the expected value.

According to this configuration, it is possible to acquire the attention point from various viewpoints.

According to a sixteenth aspect of the invention, the output information generation unit outputs display information for performing a pop-up display of statistical information of a date corresponding to a selected cell, in accordance with an operation of the user who selects the cell for a date in the calendar.

According to this configuration, it is possible to simply check statistical information of each day on the calendar.

According to a seventeenth aspect of the invention, an analysis condition setting unit that sets at least one of the target period, a target facility, a target area in the facility, and a type of a target product or service, as an analysis condition, in accordance with an operation input of the user is further provided. The evaluation unit performs statistical processing on the accounting information based on the analysis condition, and acquires the actual value and the expected value on a date corresponding to the analysis condition.

According to this configuration, it is possible to acquire the attention point from various viewpoints.

According to an eighteenth aspect of the invention, the display information generation unit outputs display information including a graph representing a transition situation of statistical information for each time slot, and outputs display information including the area image in a selected time slot, in accordance with an operation of the user who selects the time slot on the graph.

According to this configuration, it is possible to view the area image in the time slot to attract attentions on the graph, with a simple operation.

According to a nineteenth aspect of the invention, a user terminal device displays a screen transmitted from a facility operation support device that supports a task of a user who operates a facility providing a product or a service to a user. The user terminal device presents, to a user, a calendar of a target period, in which a date as an attention point acquired by evaluating a record for an operation situation of a facility on each date in the target period is shown, based on accounting information for providing a product or a service to a user, and displays a screen for causing the user to select the attention point, and displays a screen for presenting an area image in the facility corresponding to the attention point, to the user in accordance with an operation of the user who selects the attention point.

With this configuration, similar to the twelfth aspect of the invention, it is possible that a plurality of users such as a manager who manages a plurality of facilities and a manager for each facility recognizes an operation situation of a facility with high efficiency and reasonably performs a task for improving a facility operation, even in a case where the number of facilities or the number of target areas in a facility increases.

According to a twentieth aspect of the invention, a facility operation support method causes an information processing apparatus to support a task of a user who operates a facility providing a product or a service to a user. The facility operation support method includes accumulating a plurality of area image obtained by capturing a target area in the facility, acquiring accounting information for providing the product or the service to the user, acquiring an actual value and an expected value on each date in a target period based on the accounting information, comparing the actual value and the expected value on each date to each other, evaluating a record for an operation situation of the facility on each date, and acquiring a date as an attention point based on the evaluation result, acquiring the area image corresponding to the attention point from a plurality of accumulated area images, and generating display information including a calendar of the target period, which the attention point has been shown, and outputting display information including the area image corresponding to the attention point, in accordance with an operation of the user who selects the attention point.

With this configuration, similar to the twelfth aspect of the invention, it is possible that a plurality of users such as a manager who manages a plurality of facilities and a manager for each facility recognizes an operation situation of a facility with high efficiency and reasonably performs a task for improving a facility operation, even in a case where the number of facilities or the number of target areas in a facility increases.

According to a twenty-first aspect of the invention, a facility operation support device supports tasks of a first user and a second user who operate a facility providing a product or a service to a user. The facility operation support device includes a transmission unit that transmits an input screen to a first user terminal device operated by the first user who performs an instruction for a work in the facility and a second user terminal device operated by the second user who performs the work of which the instruction has been performed, and a management unit that manages information acquired on the input screen. The transmission unit transmits a first input screen for causing the first user to input instruction information regarding contents of the instruction to the first user terminal device and acquires the instruction information, transmits a second input screen for causing the second user to input report information regarding a result obtained by performing the work of which the instruction has been performed, to the second user terminal device and acquires the report information, with presenting the instruction information to the second user, and transmits a third input screen for causing the first user to input evaluation information regarding an evaluation result for a situation of performing the work of which the instruction has been performed, to the first user terminal device and acquires the evaluation information, with presenting the report information to the first user. The management unit acquires the instruction information, the report information, and the evaluation information from the transmission unit and manages status information regarding a progress status of a task relating to the instruction.

With this configuration, it is possible to collect information transmitted and received when an instruction of a work for a facility, that is, information regarding contents of the instruction, information regarding a report in response to the instruction, and information regarding an evaluation for the report with high efficiency and to appropriately manage a progress status of a task relating to an instruction.

According to a twenty-second aspect of the invention, the transmission unit acquires an area image obtained by capturing a target area in which the work of which the instruction has been performed has been performed, as the report information, in accordance with an operation input of the second user on the second input screen.

According to this configuration, since the first user can grasp the specific situation of performing the work of which the instruction has been performed, by using the area image, it is possible that the first user performs an appropriate evaluation.

According to a twenty-third aspect of the invention, an image accumulation unit that regularly acquires and accumulates the area image of each target area with a fixed type camera installed in the facility is further provided. The transmission unit acquires any one of the area image accumulated in the image accumulation unit and the area image obtained by capturing the target area with a camera held by the second user.

According to this configuration, it is possible to acquire an appropriate area image. The camera held by the second user includes a camera mounted in the second user terminal device.

According to a twenty-fourth aspect of the invention, the transmission unit transmits a browsing screen for presenting the evaluation information to the second user to the second user terminal device, and transmits the second input screen for causing the second user to input the report information regarding a result obtained by performing the work again, to the second user terminal device again and acquires the report information, in a case where the evaluation information indicates the evaluation result that the work of which the instruction has been performed is not appropriately performed.

According to this configuration, in a case where the work of which the instruction has been performed is not appropriately performed, the report is sent back, the work is performed again so as to improve the deficiency, and a performing result of the work which has been performed again is reported again. Thus, it is possible to appropriately and reliably perform the work of which the instruction has been performed.

According to a twenty-fifth aspect of the invention, the transmission unit transmits a browsing screen for presenting the status information of each of a plurality of facilities to the first user and the second user to the first user terminal device and the second user terminal device.

According to this configuration, it is possible to share the progress status of the task relating to the instruction in each facility, between the first user who manages the plurality of facilities and performs an instruction of a required work and the second user who performs the work of which the instruction has been performed in each facility. It is possible to share the progress status of the task relating to the instruction in each facility, between a plurality of second users. Thus, it is possible to promote communications between the plurality of users and to reasonably perform the store operation task.

According to a twenty-sixth aspect of the invention, a status presentation image for expressing the status information is displayed on the browsing screen, and the status information is presented to the user by changing a display form of the status presentation image.

According to this configuration, it is possible that the user immediately grasps the status information regarding the progress status of the task relating to the instruction, by the display form of the status presentation image.

According to a twenty-seventh aspect of the invention, an area image obtained by capturing a target area in which the work of which the instruction has been performed has been performed is displayed on the browsing screen, the status presentation image is a frame image that surrounds the area image, and the status information is expressed by a color and a blink state of the frame image.

According to this configuration, it is further easy that the user grasps the status information by the color and the blink state of the frame image.

According to a twenty-eighth aspect of the invention, the status presentation image comes into a first display form in a case where a task is provided for a viewer, comes into a second display form in a case where the task is provided for a person other than the viewer, and comes into a third display form in a case where the task is provided for no one.

According to this configuration, it is possible that the user immediately distinguishes a state where a task is provided for the viewer, a state where the task is provided for a person other than the viewer, and a state where the task is provided for no one, from each other by the display form of the status presentation image. In this case, if blink display is performed on the status presentation image in the first display form considered as particularly important, it is possible that the user immediately pays attentions.

According to a twenty-ninth aspect of the invention, a user terminal device displays a screen transmitted from a facility operation support device that supports tasks of a first user and a second user who operate a facility providing a product or a service to a user. The user terminal device is operated by the first user who performs an instruction for a work in the facility, displays an input screen of causing the first user to input instruction information regarding contents of the instruction, transmits the instruction information to a server apparatus, presents report information regarding a result obtained by the second user performing the work based on the instruction information, to the first user, displays an input screen for causing the first user to input evaluation information regarding an evaluation result for a situation of performing the work of which the instruction has been performed, and transmits the evaluation information to the server apparatus.

With this configuration, it is possible to collect information transmitted and received when an instruction of a work for a facility, that is, information regarding contents of the instruction and information regarding an evaluation for a report, with high efficiency.

According to a thirtieth aspect of the invention, a user terminal device displays a screen transmitted from a facility operation support device that supports tasks of a first user and a second user who operate a facility providing a product or a service to a user. The user terminal device is operated by the second user who performs a work by an instruction from the first user, presents instruction information regarding contents of the instruction to the second user, displays an input screen for causing the second user to input report information regarding a result obtained by performing the work of which the instruction has been performed, transmits the report information to a server apparatus, and presents evaluation information regarding an evaluation result which has been obtained by the first user evaluating a situation of performing the work based on the report information, to the second user, and displays a browsing screen for urging re-performing of the work in a case where the work of which the instruction has been performed is not appropriately performed.

According to this configuration, it is possible to collect information transmitted and received when an instruction of a work for a facility, that is, information regarding a report in response to the instruction, with high efficiency. In a case where the work of which the instruction has been performed is not appropriately performed, it is possible to urge the second user to perform the work again.

According to a thirty-first aspect of the invention, a facility operation support method causes an information processing apparatus to support tasks of a first user and a second user who operate a facility providing a product or a service to a user. The facility operation support method includes transmitting a first input screen for causing the first user who performs an instruction for a work in the facility to input instruction information regarding contents of the instruction, to a first user terminal device operated by the first user, presenting the instruction information to the second user who performs a work of which the instruction has been performed, and transmitting a second input screen for causing the second user to input report information regarding a result obtained by performing the work of which the instruction has been performed, to a second user terminal device operated by the second user, presenting the report information to the first user and transmitting a third input screen for causing the first user to input evaluation information regarding an evaluation result for a situation of performing the work of which the instruction has been performed, to the first user terminal device, and managing status information regarding a progress status of a task relating to the instruction, based on the instruction information, the report information, and the evaluation information.

With this configuration, according to a twenty-first aspect of the invention, it is possible to collect information transmitted and received when an instruction of a work for a facility, that is, information regarding contents of the instruction, information regarding a report in response to the instruction, and information regarding an evaluation for the report with high efficiency and to appropriately manage a progress status of a task relating to an instruction.

Hereinafter, an exemplary embodiment will be described with reference to the drawings.

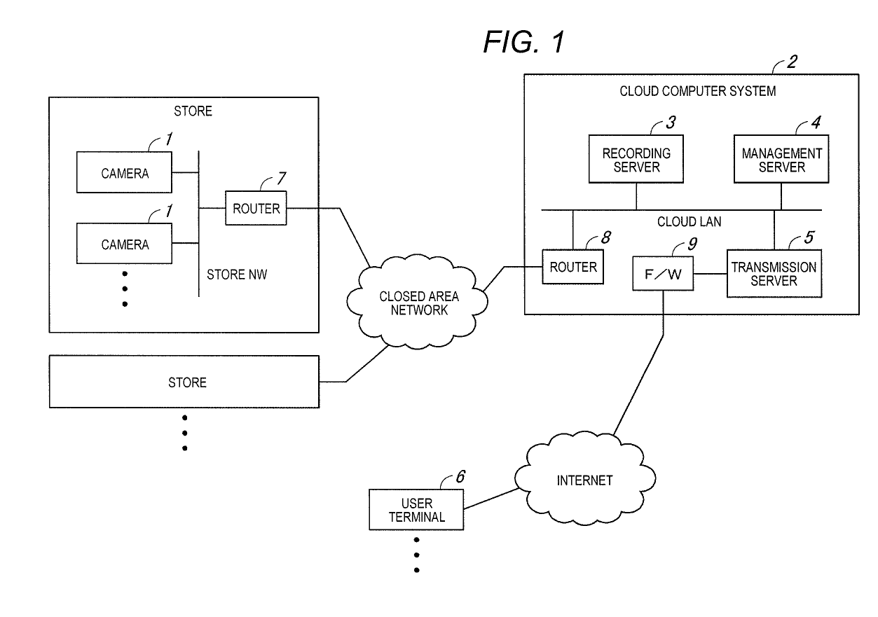

FIG. 1 is a diagram illustrating an overall configuration of a facility operation support system according to the exemplary embodiment.

The facility operation support system is constructed by setting retail chain stores such as convenience stores as targets. The facility operation support system includes camera (facility capturing device) 1 provided in each of a plurality of stores (facilities), recording server (image accumulation unit, information processing apparatus) 3, management server (management unit, information processing apparatus) 4, transmission server (transmission unit, information processing apparatus) 5, and user terminal 6. Recording server 3, management server 4, and transmission server 5 constitute cloud computer system 2.

Camera 1 is installed in a proper place in a store and images the inside of the store. Camera 1 is connected to a closed area network such as a virtual local area network (VLAN) via a network in the store and router 7.

Recording server 3, management server 4, and transmission server 5 are connected to each other via a cloud LAN. The cloud LAN is connected to the closed area network via router 8. Transmission server 5 is connected to the Internet via firewall 9.

Recording server 3 collects and accumulates camera images obtained by capturing the inside of a store, from camera 1 in each store. Management server 4 manages camera images, information regarding a user or a store, information input by a user, and the like by using a database. Transmission server (Web server) 23 generates and transmits a screen to be viewed by a user with user terminal 6, and acquires information input on the screen by the user.

User terminal 6 is, for example, a PC, a smartphone, or a tablet terminal. User terminal 6 is operated by a manager (store owner or supervisor) who manages a plurality of stores or a user such as a store manager, who manages each store, so as to allow the screen transmitted from transmission server 5 to be viewed on a Web browser or by a dedicated application.

In such a facility operation support system, camera 1 and recording server 3 are connected to the each other via the closed area network, and thus it is possible to secure safety of a communication. Since transmission server 5 and user terminal 6 are connected to each other via the Internet, it is possible to access transmission server 5 at any place by user terminal 6.

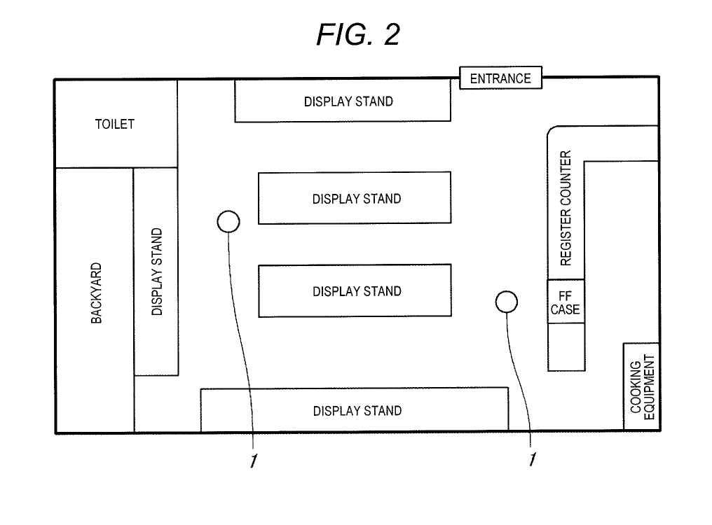

Next, a layout of a store and an installation situation of camera 1 will be described. FIG. 2 is a plan view of a store illustrating the layout of the store and the installation situation of camera 1.

An entrance, display stands, a register counter, cooking equipment, and the like are provided in the store. The display stands are installed to be separated from each other in accordance with the type of commodities such as fast food (FF), boiled rice (commodities such as rice balls, lunch boxes, and sushi), bakery, dessert, drink, processed food, side dishes, frozen food, and miscellaneous goods. The cooking equipment is for cooking fast food such as the deep-fried chicken in the store. The display stand (FF case) for fast food is installed near the register counter. A customer enters from the entrance and moves in the store through passages between the display stands. If the customer finds a desired commodity, the customer holds the commodity and moves to the register counter. Then, the customer completes accounting (payment) on the register counter and then leaves from the entrance.

A plurality of cameras 1 capturing the inside of the store is installed in the store. Camera 1 is installed at an appropriate position of the ceiling in the store. In particular, in the example illustrated in FIG. 2, an omnidirectional camera having a capturing range of 360 degrees with fish-eye lens is employed as camera 1. Thus, commodities and the like displayed in the display stands and the like can be imaged by camera 1.

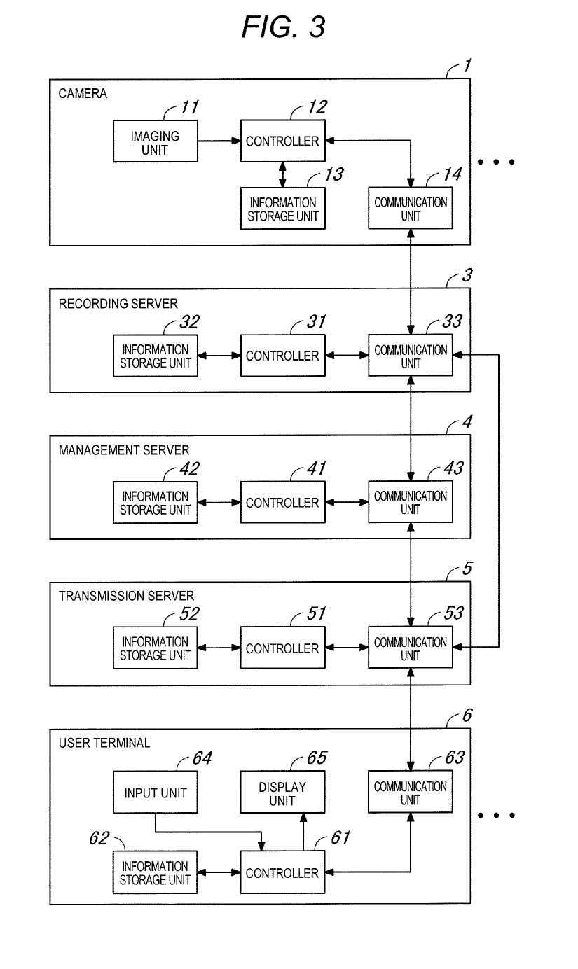

Next, the schematic configuration of camera 1, recording server 3, management server 4, transmission server 5, and user terminal 6 will be described. FIG. 3 is a block diagram illustrating a hardware configuration of camera 1, recording server 3, management server 4, transmission server 5, and user terminal 6.

Camera 1 includes capturing unit 11, controller 12, information storage unit 13, and communication unit 14.

Capturing unit 11 includes a capturing sensor and sequentially outputs consecutive captured images (frames), so-called a moving image. Controller 12 is configured with a processor. The controller performs image processing on a captured image so as to generate a processed image (here, a moving-body removal image which is suitable for monitoring commodities displayed in the store and in which a customer or the like has been removed). The controller outputs the processed image. Information storage unit 13 stores a program executed by controller 12 or the captured image output from capturing unit 11. Communication unit 14 transmits the processed image output from controller 12 to recording server 3 via the network.

Recording server 3 includes controller 31, information storage unit 32, and communication unit 33.

Communication unit 33 transmits and receives required information to and from camera 1. In particular, the communication unit receives a camera image which is regularly transmitted from camera 1. For example, the communication unit regularly transmits an image transmission request at a predetermined timing (for example, an interval of 15 minutes) to each camera 1, and receives a camera image transmitted from camera 1 in response to the image transmission request. Communication unit 33 transmits and receives required information to and from management server 4 or transmission server 5. Information storage unit 32 stores the camera image of each camera 1, which has been received by communication unit 33 and a program executed by controller 31. Controller 31 is configured with a processor and performs image processing on a camera image acquired from camera 1. In the image processing, distortion correction of a camera image which is a fish-eye image or processing of extracting an area image obtained by capturing a predetermined target area (display stand or the like of each commodity type).

Management server 4 includes controller 41, information storage unit 42, and communication unit 43.

Controller 41 is configured with a processor. The controller performs processing of managing information (for example, file name and preservation path) regarding an area image, information regarding a user and a store, information input by a user, and the like by using a database. Information storage unit 42 stores information regarding the database or a program executed by controller 41. Communication unit 43 transmits and receives required information to and from recording server 3 or transmission server 5. For example, communication unit 43 receives information regarding area images accumulated in recording server 3 from recording server 3, and receives information input by a user from transmission server 5.

In particular, in the exemplary embodiment, controller 41 performs, for example, processing of evaluating a display state of a commodity in a display area (display stand or the like) in a store, based on the area image.

Transmission server 5 includes controller 51, information storage unit 52, and communication unit 53.

Controller 51 is configured with a processor and performs processing of generating a screen viewed by the user with user terminal 6. Information storage unit 52 stores a program executed by controller 51. Communication unit 53 transmits and receives required information to and from recording server 3 or management server 4. Communication unit 53 transmits and receives required information to and from user terminal 6. For example, communication unit 53 transmits screen information generated by controller 51 to user terminal 6 and receives information input by a user with user terminal 6.

User terminal 6 includes controller 61, information storage unit 62, communication unit 63, input unit 64, and display unit 65.

Input unit 64 is used when a user inputs various kinds of setting information. Display unit 65 displays a screen based on screen information transmitted from transmission server 5. Input unit 64 and display unit 65 can be configured as a touch panel display. Communication unit 63 performs a communication with transmission server 5. Communication unit 63 transmits user setting information input by input unit 64 to transmission server 5 and receives screen information transmitted from transmission server 5. Controller 61 is configured with a processor and controls the components of user terminal 6. Information storage unit 62 stores a program executed by controller 61 and the like.

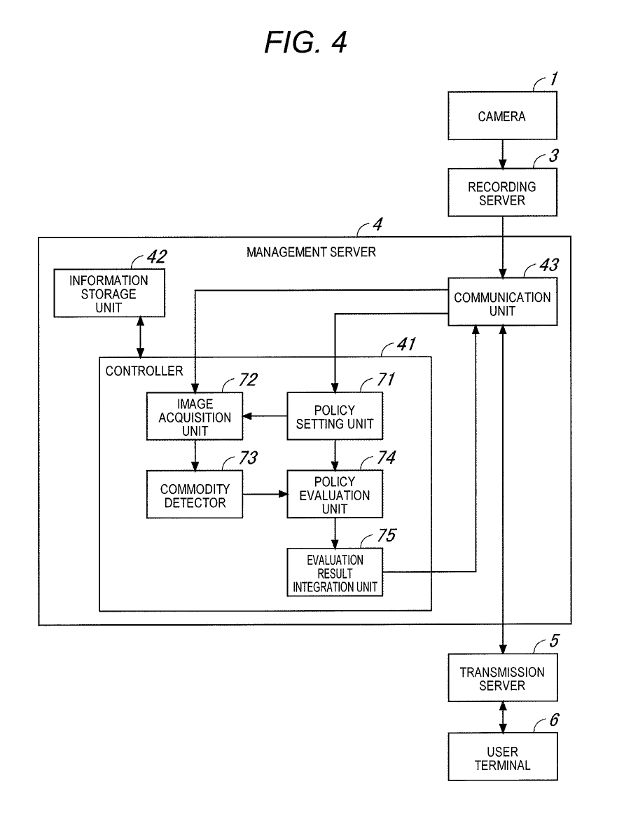

Next, a functional configuration of management server 4 will be described. FIG. 4 is a functional block diagram illustrating management server 4.

Controller 41 in management server 4 includes policy setting unit 71, image acquisition unit 72, commodity detector (product detector) 73, policy evaluation unit 74, and evaluation result integration unit 75. The components of controller 41 are realized in a manner that the processor constituting controller 41 executes a program (instruction) for monitoring, which has been stored in information storage unit 42.

Policy setting unit 71 sets a plurality of policies in which evaluation conditions when the display state of commodities is evaluated have been respectively defined, in accordance with an operation input of a user. In the exemplary embodiment, an attention area as an evaluation target of the display state of commodities, a display index (evaluation item) as an index when the display state of commodities is evaluated, an evaluation time point (evaluation timing) at which the display state of commodities is evaluated, and an evaluation criterion (threshold) as a reference when the display state of commodities is evaluated are defined as the evaluation condition, for each policy.

Image acquisition unit 72 acquires an area image (image obtained by capturing a target area) which has been transmitted from recording server 3 and received by communication unit 33. In the exemplary embodiment, the image acquisition unit acquires an area image obtained by capturing an attention area which has been set by policy setting unit 71.

Commodity detector 73 acquires commodity detection information indicating the position of a commodity in the attention area, based on an area image which has been acquired by image acquisition unit 72 and is obtained by capturing the attention area. In the exemplary embodiment, a commodity detection image in which a commodity region and other regions have been represented by binary images is generated as the commodity detection information. Here, if commodities in the attention area are recognized by using an object recognition technology with machine learning, commodity detection information in which the commodities are classified with colors by, for example, a commodity type can be acquired. Specifically, commodities of which learning has been performed in advance and a display tray on which the commodities are displayed may be set as candidates. Each recognizer may vote for a candidate corresponding to a recognition target. Candidates voted by the recognizer may be aggregated, and the number of votes for each candidate may be obtained. Then, the commodity detection information may be generated by using the candidate having the most number of votes as the final recognition result.

Policy evaluation unit 74 evaluates an achievement situation of a policy based on the display index of each policy, which has been set by policy setting unit 71. In the exemplary embodiment, the policy evaluation unit calculates an evaluation index (evaluation value) corresponding to the display index based on the commodity detection information (commodity detection image) acquired by commodity detector 73, and evaluates the achievement situation of the policy based on the evaluation index.

In the exemplary embodiment, a display quantity, a face-up degree, an alignment degree, a volume degree, and a stockout continuity degree can be defined as display indices, for each policy. One display index can be defined for one policy.

The display quantity and the stockout continuity degree are display indices relating to commodity display deficiency. The face-up degree, the alignment degree, and the volume degree are indices relating to display disturbance of commodities. Specifically, the display quantity is an occupancy degree (occupancy ratio) indicating the degree (proportion) of occupation of commodities in an area in which the commodities are displayed. The face-up degree indicates the degree of commodities being displayed side by side at a frontmost position. The alignment degree indicates the degree of aligning and displaying commodities in a left-right direction. The volume degree indicates the degree of collectively displaying a large amount of commodities. The stockout continuity degree indicates the degree of a length of a duration of a stockout state in which a commodity is short.

Policy evaluation unit 74 evaluates the achievement situation of a policy based on the evaluation criterion defined for each policy. In the exemplary embodiment, the policy evaluation unit evaluates the achievement situation of a policy at two stages of being good and poor, by comparing the evaluation index calculated based on the commodity detection information to a predetermined threshold (evaluation criterion).

Policy evaluation unit 74 evaluates the achievement situation of a policy by an evaluation time point defined for each policy. In particular, regarding the display quantity, a time slot (before a peak, before delivery, and the like) considered as important is roughly determined, and replenishment of commodities is not possible in some cases. Therefore, in an evaluation in which the display quantity is used as the display index, the policy evaluation unit sets an evaluation time point and performs an evaluation at the evaluation time point. Since performing works for improving the volume degree, the alignment degree, and the face-up degree is possible at any time, an evaluation in which the volume degree, the alignment degree, and the face-up degree are used as display indices may be regularly performed.

Policy evaluation unit 74 evaluates the achievement situation of a policy for each predetermined unit time. In the exemplary embodiment, the policy evaluation unit acquires an evaluation result in a unit of one day, for each policy, by setting one day as the unit time. Here, in a case where an evaluation with the evaluation time point defined for each policy is performed, if a plurality of evaluation time points for one day is defined, a plurality of evaluation results is obtained for each evaluation time point. Thus, the evaluation results at the evaluation time points are aggregated (subjected to statistical processing) so as to acquire an evaluation result in a unit of one day. Even in a case where an evaluation is regularly performed, evaluation results at the time points are aggregated so as to acquire an evaluation result in a unit of one day.

Aggregation of the evaluation results may be performed by majority vote, for example. That is, in a case where the number of evaluation results determined to be good is greater than the number of evaluation results determined to be poor among evaluation results of the time points in one day, the evaluation result in a unit of one day is determined to be good. In a case where the number of evaluation results determined to be poor is greater than the number of evaluation results determined to be good, the evaluation result in a unit of one day is determined to be poor. In addition, a proportion of the number of evaluation results determined to be good (poor) to the number of evaluation results for one day may be calculated. The evaluation result in a unit of one day may be obtained by comparing the calculated proportion to a predetermined threshold (determination criterion). In this case, the threshold may be set in advance, or may be designated by a user.

Evaluation result integration unit 75 integrates evaluation results obtained for each policy by policy evaluation unit 74, in a unit of a store so as to acquire an evaluation result in a unit of a store. In the exemplary embodiment, the evaluation result integration unit acquires an evaluation score as the evaluation result in a unit of a store.

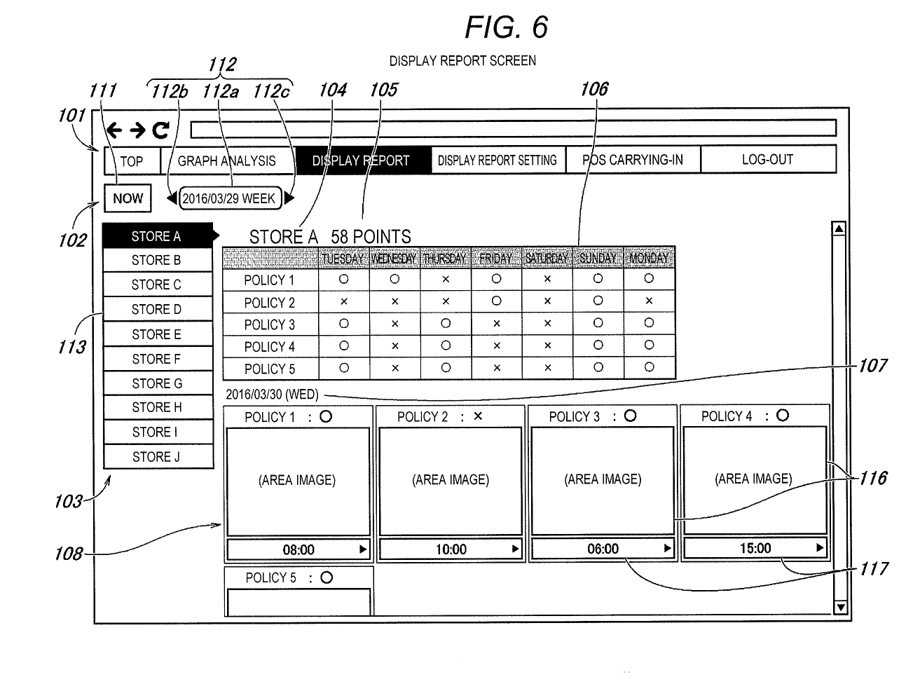

If the management server apparatus acquires the evaluation result in a unit of a policy and the evaluation result in a unit of a store in this manner, information regarding the evaluation result is transmitted to transmission server 5 (evaluation information presentation unit). Transmission server 5 generates display information regarding a display report screen (see FIG. 6) based on the information regarding the evaluation result, which has been acquired from management server 4, and transmits the display information to user terminal 6. Thus, the display report screen is displayed in user terminal 6.

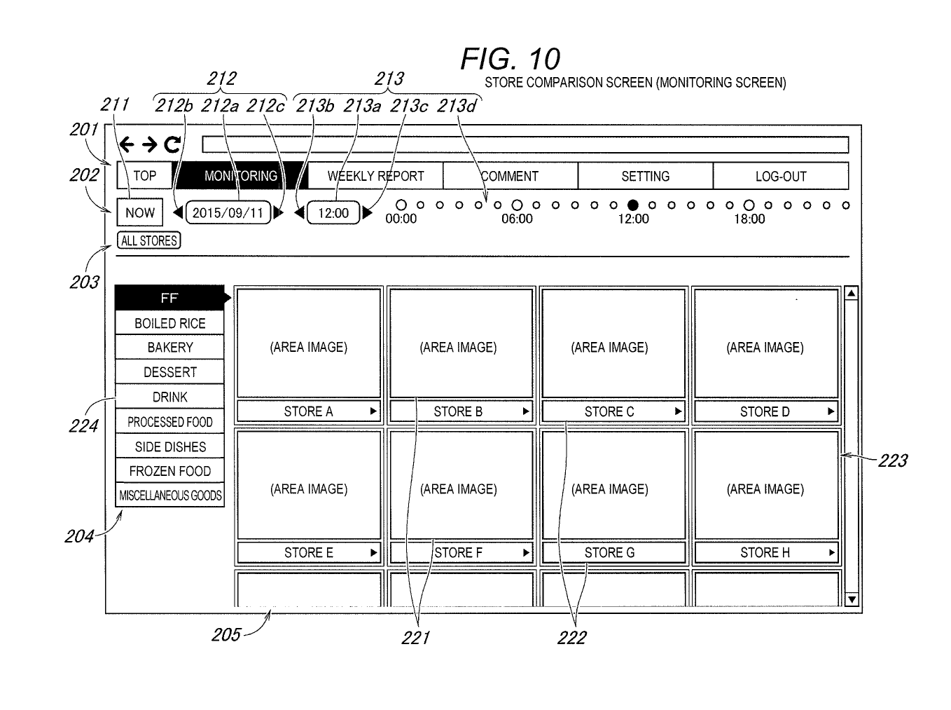

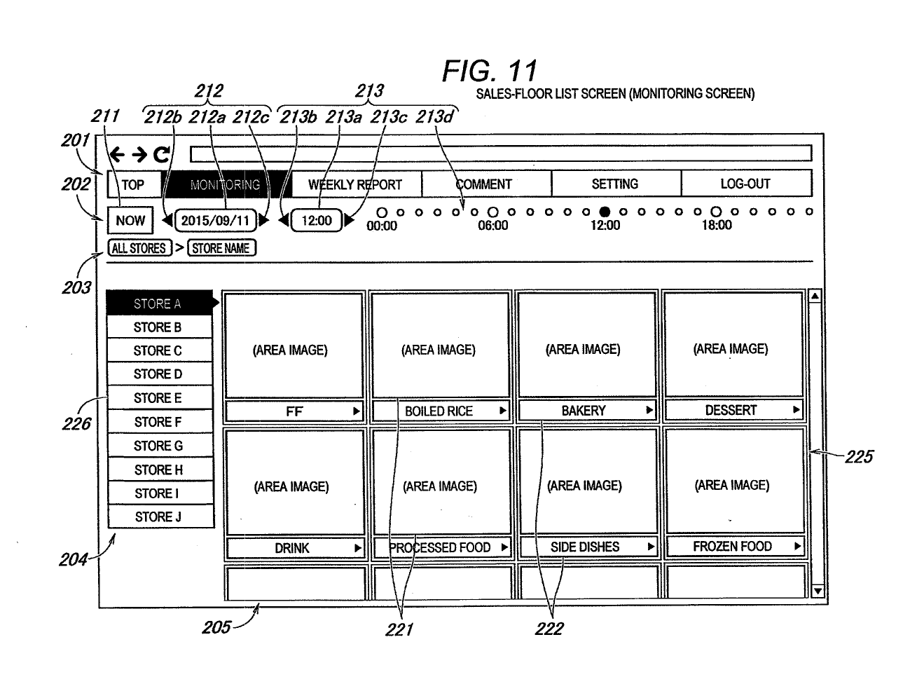

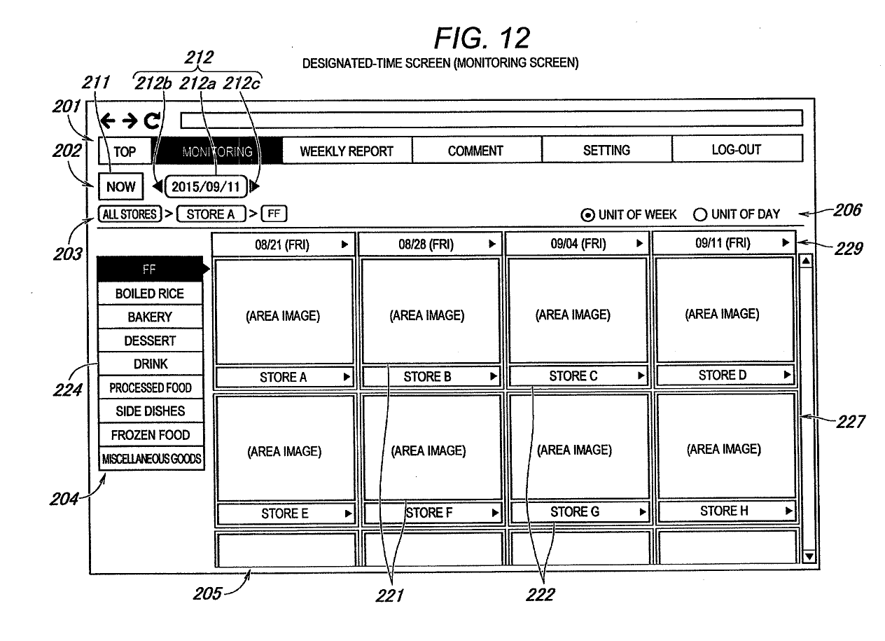

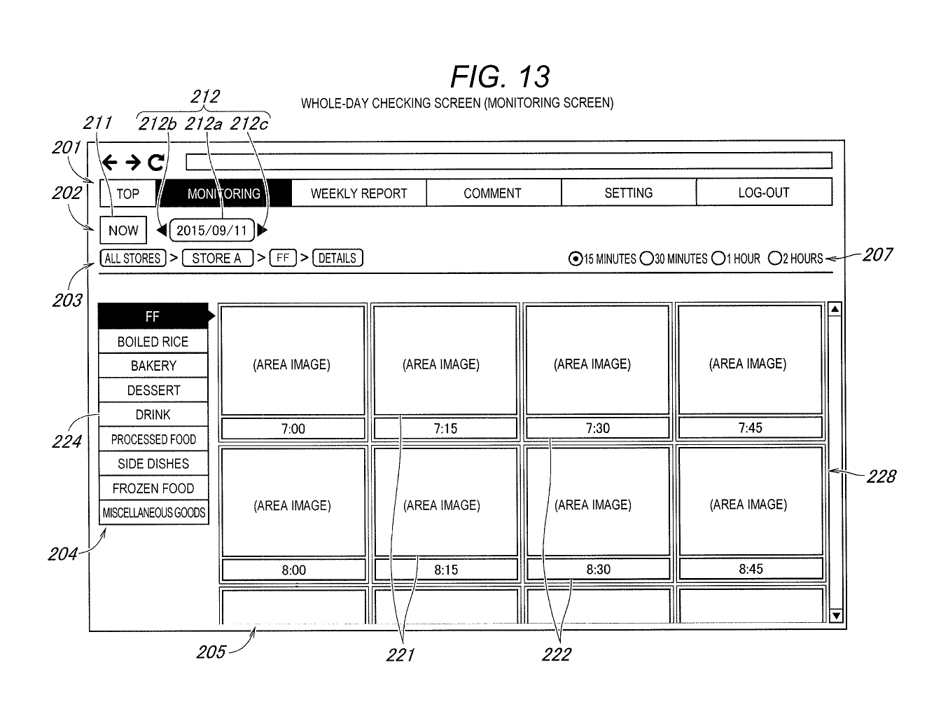

In the exemplary embodiment, transmission server 5 generates display information regarding a monitoring screen, that is, a store comparison screen (see FIG. 10), a sales-floor list screen (see FIG. 11), a designated-time screen (see FIG. 12), and a whole-day checking screen (see FIG. 13), based on the information acquired from management server 4. The transmission server transmits the display information to user terminal 6. Thus, the monitoring screen is displayed in user terminal 6.

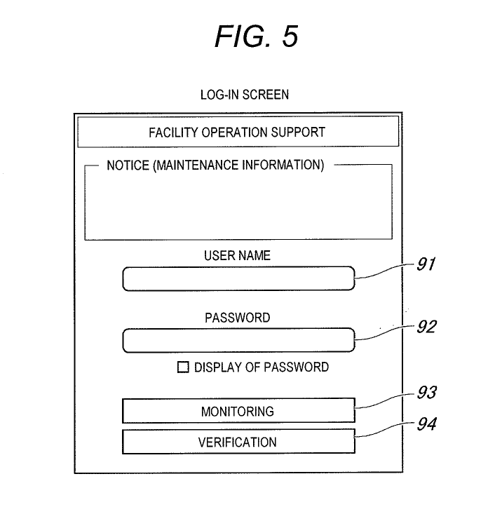

Next, a log-in screen displayed in user terminal 6 will be described. FIG. 5 is a diagram illustrating the log-in screen displayed in user terminal 6.

If user terminal 6 starts a Web browser to access transmission server 5, firstly, the log-in screen illustrated in FIG. 5 is displayed in the user terminal. In the exemplary embodiment, user authentication is performed with a user name and a password. Input portions 91 and 92 for a user name and a password are provided on the log-in screen.

In the exemplary embodiment, an authority for using a monitoring function and an authority for using a verification function are assigned to users different from each other. In a case using the monitoring function, log-in is performed by operating button 93 for “monitoring”. In a case using the verification function, log-in is performed by operating button 94 for “verification”.

Here, if a user to which the authority for using the monitoring function has been assigned operates button 93 for monitoring and an attempt of user authentication succeeds, the screen is transitioned to the store comparison screen (see FIG. 10) which is the top screen for the monitoring function. If a user to which the authority for using the verification function has been assigned operates button 94 for verification and an attempt of user authentication succeeds, the screen is transitioned to a graph analysis screen (not illustrated) which is the top screen for the verification function.

Next, the display report screen displayed in user terminal 6 will be described. FIG. 6 is a diagram illustrating the display report screen displayed in user terminal 6.

The display report screen illustrated in FIG. 6 is provided for presenting an evaluation result for each of a plurality of policies to the user. Main menu 101, target period designation portion 102, selection menu display portion 103, store display portion 104, evaluation score display portion 105, evaluation digest display portion 106, selected-day display portion 107, and image list display portion 108 are provided in the display report screen.

In main menu 101, any of the top, graph analysis, a display report, a display report setting, POS carrying-in, and log-out is allowed to be selected by a selection operation (clicking or tapping).

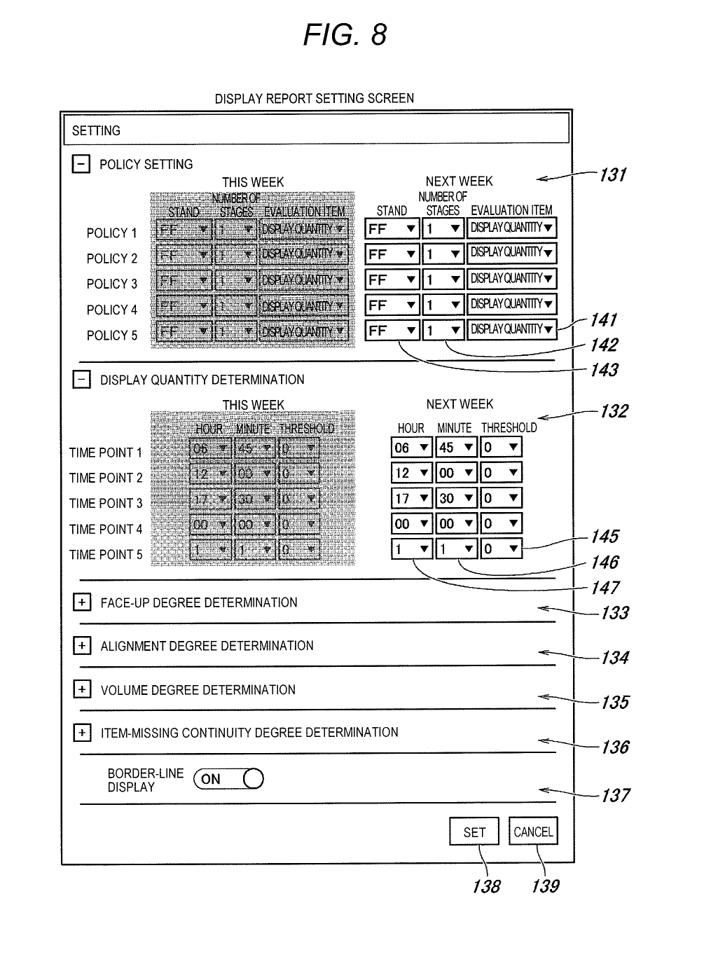

If the top is selected in main menu 101, the screen is transitioned to a monthly graph analysis screen (not illustrated) which is the top screen for the verification function. If the graph analysis is selected in main menu 101, the screen is transitioned to the monthly graph analysis screen (not illustrated) which is the top screen. If the display report is selected in main menu 101, the screen is transitioned to the display report screen (see FIG. 6). If the display report setting is selected in main menu 101, the screen is transitioned to the display report setting screen (see FIG. 8). If the POS carrying-in is selected in main menu 101, the screen is transitioned to a POS carrying-in screen (not illustrated). If the log-out is selected in main menu 101, the screen in the process of being displayed is closed, and the screen is brought back to the log-in screen (see FIG. 5).

A calendar in which the date as an attention point for one month as a target has been displayed, and a graph representing a transition situation of a statistical value for the one month as the target are displayed side by side on the monthly graph analysis screen. The POS carrying-in screen is provided for designating POS information as a source of an evaluation when an attention point is acquired.

Target period designation portion 102 is used for causing the user to designate a target period of an evaluation. Evaluation results of days in the target period designated here are displayed at evaluation digest display portion 106. In the exemplary embodiment, the target period is set to one week from a day set as a reference, and evaluation results for one week are displayed at evaluation digest display portion 106.

NOW button 111 and target period change portion 112 are provided at target period designation portion 102. If the user operates NOW button 111, evaluation results of days for this one week are displayed at evaluation digest display portion 106. Thus, in a case where the user wants to check evaluation results for this week after having checked the previous evaluation results, the evaluation results for this week can be rapidly displayed.

Period display portion 112a, leftward arrow button 112b, and rightward arrow button 112c are provided at target period change portion 112. If the user operates period display portion 112a, a calendar screen (not illustrated) is displayed, and a week is allowed to be selected on the calendar screen. Arrow buttons 112b and 112c perform weekly feeding. If the user operates leftward arrow button 112b, the target period is changed to a week before one week. If the user operates rightward arrow button 112c, the target period is changed to a week after one week.

Store selection menu 113 is displayed at selection menu display portion 103. If the user selects a store on store selection menu 113, the contents of evaluation digest display portion 106 are switched to an evaluation digest for the selected store.

The name of a store in the process of being displayed is displayed at store display portion 104.

Evaluation score display portion 105 is provided for presenting an evaluation score (total score) for a store attracting attentions to the user. The evaluation score is calculated based on the evaluation result (0 or X) of each policy in each day for one week as the target period. Specifically, the number of times of the evaluation result being determined to be good (O) is counted, and a proportion of evaluation results determined to be good to the total number of evaluation results is calculated as the evaluation score.

Evaluation digest display portion 106 is provided for presenting digest information in which a list of evaluation results of each policy for each one day (unit time) has been displayed to the user. In the exemplary embodiment, evaluation results (O or X) of each policy in each day for one designated week (target period) are displayed in a list, as the digest information, at evaluation digest display portion 106. In this list, days in one week are displayed side by side in order from a day set as a reference (for example, Tuesday). In addition, the evaluation result determined to be good is indicated by “O”, and the evaluation result determined to be poor is indicated by “X”.

In the exemplary embodiment, the unit time is set to one day. However, for example, the unit time may be set to one week, and a list of evaluation results of a policy in each one week for one month may be displayed.

If a day-of-week display field of evaluation digest display portion 106, that is, a cell in which a day has been displayed and a cell in which an evaluation result (O or X) of each policy in that day are selection-operated, the date corresponding to that day is displayed at selected-day display portion 107, and an area image of each policy on that day is displayed at area image display portion 116.

The date corresponding to the day selected at evaluation digest display portion 106 by the user is displayed at selected-day display portion 107.

Area image display portion 116 for each policy and time-point display portion 117 are provided at image list display portion 108. Area image display portion 116 is used for presenting an attention area of each policy, which corresponds to the evaluation result of each policy, that is, an area image (captured image) obtained by capturing an area as a target of the policy, to the user. An area image of each policy in a day selected at evaluation digest display portion 106 by the user is displayed at area image display portion 116.

A capturing time point of an area image displayed at area image display portion 116 is displayed at time-point display portion 117. If the user operates time-point display portion 117, the screen is transitioned to the store comparison screen (see FIG. 10). At this time, an area image of each store at a time point in time-point display portion 117 which has been operated is displayed on the store comparison screen. An area image (corresponding to the operated time-point display portion 117) of an area (sales floor for each commodity type) as a target of a policy is displayed on the store comparison screen.

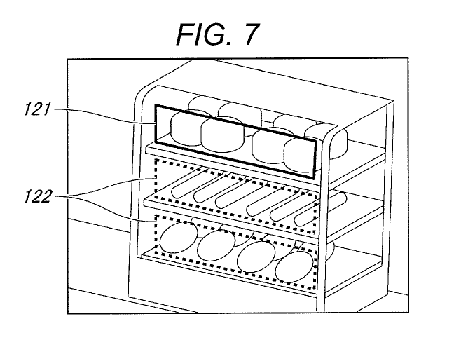

Next, an area image displayed at area image display portion 116 of the display report screen will be described. FIG. 7 is a diagram specifically illustrating the area image displayed at area image display portion 116 of the display report screen.

An image obtained by superimposing frame image 121 showing a range of an attention area on an area image obtained by capturing the attention area as a target of a policy is displayed in area image display portion 116. Frame image 122 is also displayed on a target area (state surveillance area) other than the attention area, in area image display portion 116. The attention area can be distinguished from another target area by changing display forms of frame images 121 and 122. Specifically, frame image 121 to be displayed on the attention area is drawn with a solid line. Frame image 122 to be displayed on a target area other than the attention area is drawn with a dot line.

An attention area as a target of a policy is designated in a target area (state surveillance area), on the display report setting screen (see FIG. 8) by a user. In the example illustrated in FIG. 7, three target areas are respectively set for shelf boards of a display stand for fast food. Any can be designated as an attention area by the user. Since one attention area is set for each policy, only one frame image 121 drawn with a solid line is displayed.

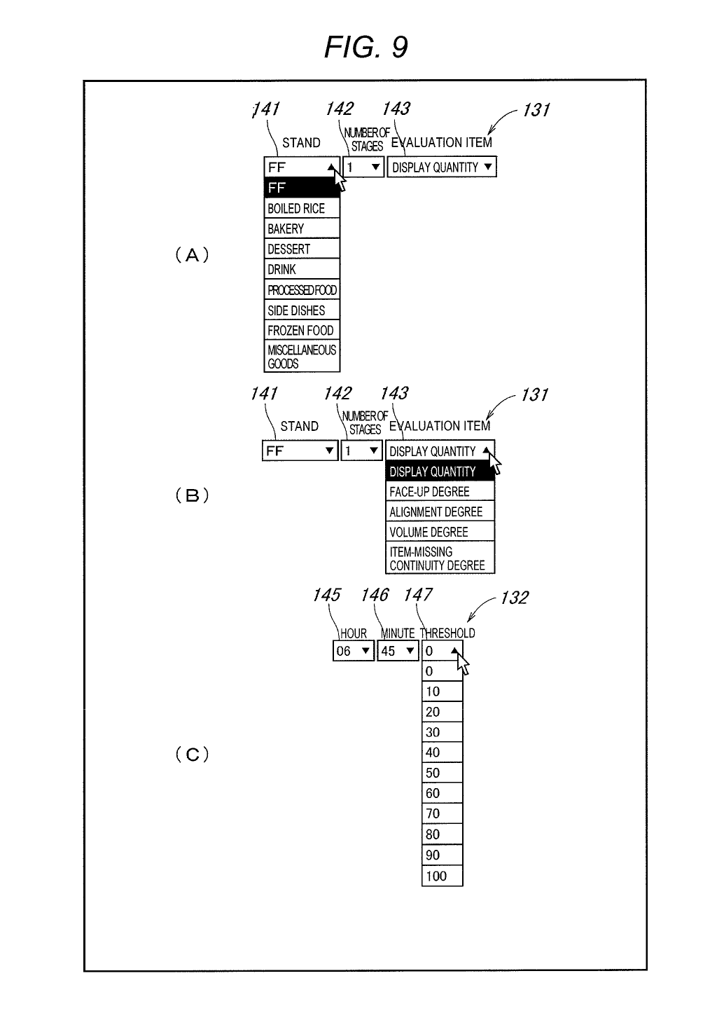

Next, the display report setting screen displayed in user terminal 6 will be described. FIG. 8 is a diagram illustrating the display report setting screen displayed in user terminal 6. FIG. 9 is a diagram illustrating a selection menu displayed on the display report setting screen.

If the display report setting is selected in main menu 101 in the display report screen (see FIG. 6) or the graph analysis screen (not illustrated) which is firstly displayed at time of log-in, the screen is transitioned to the display report setting screen illustrated in FIG. 8.

The display report setting screen is provided for causing the user to input a policy in which the evaluation condition has been variously changed. In the exemplary embodiment, a plurality of policies in which a target area, an evaluation item, and an evaluation criterion have individually defined as evaluation conditions can be set. An evaluation is performed based on the evaluation condition set on the display report setting screen, and an evaluation result for each of a plurality of policies is displayed on the display report screen (see FIG. 6).

Policy designation portion 131, determination condition designation portions 132 to 136 for a display quantity, a face-up degree, an alignment degree, a volume degree, and a stockout continuity degree, border-line display designation portion 137, set button 138, and cancel button 139 are provided on the display report setting screen.

A target area and an evaluation item among evaluation conditions for each policy are designated at policy designation portion 131 by the user. The target area is designated by a stand (display stand for each commodity type) and the number of stages (position of a shelf board on the display stand). Stand selection portion 141, number-of-stages selection portion 142, and evaluation item selection portion 143 are provided at policy designation portion 131.

If the user operates stand selection portion 141, as illustrated in FIG. 9(A), a stand selection menu (list box) is displayed. A display stand for each commodity type, for example, fast food (FF), boiled rice, and bakery is allowed to be selected on the stand selection menu by the user. If the user operates number-of-stages selection portion 142, a number-of-stages selection menu (list box) is displayed. The number (1, 2, . . . ) of stages of shelf boards of the display stand is allowed to be selected on the number-of-stages selection menu by the user. If the user operates evaluation item selection portion 143, an evaluation item selection menu (list box) is displayed. As illustrated in FIG. 9(B), the display quantity, the face-up degree, the alignment degree, the volume degree, and the stockout continuity degree are allowed to be selected as evaluation items on the evaluation item selection menu by the user.

Fields for this week and the next week are provided at policy designation portion 131. An evaluation condition for this week is displayed in the field for this week. The evaluation condition for this week is displayed for a reference when an evaluation condition for the next week is input, and is displayed to be greyed out (indicating that an operation is not possible) such that the evaluation condition for this week is not changed in the middle of the week. An evaluation condition which is the same as that for this week in an initial state is displayed in the field for the next week in a state of being input in advance.

An evaluation criterion for the evaluation condition of each policy is designated in each of determination condition designation portions 132 to 136 for the display quantity, the face-up degree, the alignment degree, the volume degree, and the stockout continuity degree, by the user. Evaluations for evaluation items (display quantity, face-up degree, alignment degree, volume degree, and stockout continuity degree) selected at policy designation portion 131 are performed based on evaluation criteria designated at determination condition designation portions 132 to 136.

In particular, a plurality of evaluation time points can be designated at determination condition designation portion 132 for the display quantity, and a threshold as a determination criterion for each of the evaluation time points can be designated by the user. Hour selection portion 145, minute selection portion 146, and threshold selection portion 147 are provided at determination condition designation portion 132 for the display quantity.

A time slot in which the display quantity is considered as important, for example, time before a peak, time after the peak, time for disposal and the like is selected at hour selection portion 145 and minute selection portion 146 by the user. Since the time slot in which the display quantity is considered as important is obvious, such a time slot may be displayed in a state of being input, as an initial value, in advance. The threshold relates to the percentage of the display quantity (commodity occupancy ratio). As illustrated in FIG. 9(C), the threshold can be selected in increments of 10, in a range of 0 to 100.

Evaluation criteria for the face-up degree, the alignment degree, the volume degree, and the stockout continuity degree are designated at determination condition designation portions 133 to 136 for the face-up degree, the alignment degree, the volume degree, and the stockout continuity degree by the user, respectively.

Here, regarding the display quantity, it may be not possible to undertake a work for resolving deficiency according to the stock. However, regarding any of determination items for the face-up degree, the alignment degree, and the volume degree, the work for resolving deficiency can be performed. Thus, it is necessary that a state in which deficiency does not occur at all is normally maintained. For example, thresholds relating to a duration of a deficiency state may be designated as the evaluation criteria of the determination items.

Whether or not frame image 121 or 122 (see FIG. 7) is displayed at area image display portion 116 on the display report screen (see FIG. 6) is selected at border-line display designation portion 137 by the user.

If the user operates set button 138, processing of applying setting contents input on the display report setting screen to setting information regarding a display report, which is managed by management server 4 is performed. Then, the display report setting screen is closed. If the user operates cancel button 139, the display report setting screen is closed without applying the input contents.

In the exemplary embodiment, an evaluation result (0 or X) for each policy in a unit of one day is displayed at evaluation digest display portion 106 on the display report screen (see FIG. 6). Therefore, in a case where a plurality of evaluation time points is designated at determination condition designation portion 132 for the display quantity, evaluation results at the plurality of designated evaluation time points are integrated in a unit of one day so as to acquire the evaluation result in a unit of one day. Then, the evaluation result in a unit of one day is displayed at evaluation digest display portion 106.

At this time, the evaluation result (O or X) at each evaluation time point is acquired by comparing the display quantity at the evaluation time point to a threshold for each evaluation time point. In a case where the number of evaluations in one day, that is, the proportion of the number of times of the evaluation result being determined to be good (O) to the total number of the designated evaluation time points is equal to or greater than a predetermined reference value, the evaluation result in a unit of one day may be determined to be good (O). Here, the reference value may be designated by the user or may be set in advance. For example, if the reference value is set to 50%, the evaluation result in a unit of one day is determined by majority vote.

If at least one evaluation result determined to be poor (X) is provided among evaluation results at the evaluation time points in one day, an evaluation result for one day may be determined to be poor (X). If all the evaluation results at the evaluation time points in one day indicate being good (O), the evaluation result for one day may be determined to be good (O). If all the evaluation results at the evaluation time points in one day indicate being poor (X), the evaluation result for one day may be determined to be poor (X). In other cases, the evaluation result for one day may be determined to be normal (Δ).

Separated from the threshold for each evaluation time point, a threshold relating to an evaluation in a unit of one day may be set. In this case, the proportion of the number of evaluation results determined to be good (O) to the number of evaluations for one day may be set as the evaluation index (evaluation value), and the evaluation result (O or X) in a unit of one day may be acquired by comparing the evaluation index to the threshold for an evaluation in a unit of one day. For example, in a case where four evaluation time points are designated, if evaluation results at the three evaluation time points are determined to be good (O), the evaluation index is 75. If the threshold is 50, the evaluation result in a unit of one day indicates being good (O).

In the exemplary embodiment, one threshold is set for each evaluation time point, and an evaluation is performed at the two stages of being good (O) and poor (X). However, a plurality of thresholds may be set, and an evaluation may be performed at three stages, for example.

In the exemplary embodiment, only one area image is assumed to be displayed, for each policy, at area image display portion 116 on the display report screen (see FIG. 6). Therefore, in a case where the plurality of evaluation time points has been designated at determination condition designation portion 132 for the display quantity, an area image at any of the plurality of evaluation time points is displayed. At this time, in a case where the evaluation result for one day indicates being good (O), an area image at an evaluation time point for which an evaluation is highest among the evaluation time points in one day is displayed at area image display portion 116, as a representative image. In a case where the evaluation result for one day indicates being poor (X), an area image at an evaluation time point for which an evaluation is lowest among the evaluation time points in one day is displayed at area image display portion 116, as a representative image.

A plurality of area images at evaluation time points may be displayed at area image display portion 116 of the display report screen (see FIG. 6). In this case, for example, a plurality of area images may be displayed by a scrolling or switching operation. Thus, even in a case where the evaluation result in a unit of one day indicates being good, the actual situation at an evaluation time point for which an evaluation result is determined to be poor can be specifically checked by an area image at that time.

Next, the monitoring screen (store comparison screen, sales-floor list screen, designated-time screen, and whole-day checking screen) displayed in user terminal 6 will be described. FIG. 10 is a diagram illustrating the store comparison screen displayed in user terminal 6. FIG. 11 is a diagram illustrating the sales-floor list screen displayed in user terminal 6. FIG. 12 is a diagram illustrating the designated-time screen displayed in user terminal 6. FIG. 13 is a diagram illustrating the whole-day checking screen displayed in user terminal 6.

If the user operates button 93 for monitoring on the log-in screen (see FIG. 5), the screen is transitioned to the store comparison screen illustrated in FIG. 10. If the user operates time-point display portion 117 on the display report screen (see FIG. 6), the screen is transitioned to the store comparison screen. At this time, the store comparison screen is displayed with a time point at which time-point display portion 117 has been operated on the display report screen, as a display time point.

The store comparison screen illustrated in FIG. 10 is provided for performing comparison of a situation of the common sales floor between the stores, by using the common sales floor as a target. Main menu 201, date designation portion 202, site map display portion 203, selection menu display portion 204, and image list display portion 205 are provided on the store comparison screen.

In main menu 201, any of the top, monitoring, a weekly report, a comment, setting, and log-out is allowed to be selected by a selection operation (clicking or tapping).

If the top is selected in main menu 201, the screen is transitioned to the store comparison screen (FIG. 10) as the top screen for the monitoring function. If the monitoring is selected in main menu 201, the screen is transitioned to the store comparison screen as the top screen of the monitoring screen.

If the weekly report is selected in main menu 201, a sub-menu is displayed. With a selection operation of the sub-menu, the screen is transitioned to a weekly-report list screen (not illustrated) or a weekly-report detail screen (not illustrated). The weekly-report list screen is used for causing a manager or a store manager to check the situation of each store in a weekly report (report in response to a weekly instruction). The weekly-report detail screen (not illustrated) is used for causing a store manager to perform a weekly report and causing a manager to check the weekly report input by the store manager.

If the comment is selected in main menu 201, a sub-menu is displayed. With a selection operation of the sub-menu, the screen is transitioned to a comment list screen (not illustrated) or a comment setting screen (not illustrated). The comment list screen (not illustrated) is used for display a list of a comment of which a designated person such as a store manager is notified at an appropriate timing by a manager. The comment setting screen (not illustrated) is used for inputting a new comment.

If the setting is selected in main menu 201, a sub-menu is displayed. With a selection operation of the sub-menu, the screen is transitioned to a user setting screen (not illustrated), a topic setting screen (not illustrated), or a password change screen (not illustrated). The user setting screen (not illustrated) is used for designating various user setting items. The topic setting screen is used for inputting a topic of which store managers of all stores are notified at once by a manager.

If the log-out is selected in main menu 201, the screen which is in the process of being displayed and relates to the monitoring function is closed, and the screen is brought back to the log-in screen (see FIG. 5).

Date designation portion 202 is used for designating the display date and time of the area image at image list display portion 205. An area image for the designated date and time is displayed at image list display portion 205. NOW button 211, date change portion 212, and time-point change portion 213 are provided at date designation portion 202.

If the user operates NOW button 211, an area image at the current time point (the latest image acquisition time point) is displayed at image list display portion 205.

Date display portion 212a, leftward arrow button 212b, and rightward arrow button 212c are provided at date change portion 212. If the user operates date display portion 212a, the calendar screen (not illustrated) is displayed, and the date is allowed to be selected on the calendar screen. Arrow buttons 212b and 212c perform daily feeding. If the user operates leftward arrow button 212b, the display date and time is changed to a day before one day. If the user operates rightward arrow button 212c, the display date and time is changed to a day after one day.

Time-point display portion 213a, leftward arrow button 213b, rightward arrow button 213c, and time bar 213d are provided at time-point change portion 213. Arrow buttons 213b and 213c perform time feeding corresponding to a timing (for example, an interval of 15 minutes) of image acquisition. If the user operates leftward arrow button 213b, the display time point is changed to a time point (for example, before 15 minutes) corresponding to a timing before one interval. If the user operates rightward arrow button 213c, the display time point is changed to a time point (for example, after 15 minutes) corresponding to a timing after one interval.

Time bar 213d is used for selecting a time slot in the operation time. If a point indicating a time slot is selected, the time is changed to a time point indicating the selected point.

Site map display portion 203 is provided for displaying a transition situation of the screen. Buttons of “all stores”, “store name”, “sales-floor name”, and “details” are displayed at the site map display portion 203 in accordance with the monitoring screen (see FIGS. 10 to 13). If the user operates the button, the screen is transitioned to the corresponding monitoring screen.

A plurality of area image display portions 221 arranged vertically and horizontally, and explanation display portions 222 which are respectively disposed under area image display portions 221 are provided at image list display portion 205. In particular, image-by-store list 223 in which an area image of each store, which relates to the common sales floor has been arranged along with a store name is displayed at image list display portion 205 on the store comparison screen. An area image of each store is displayed at area image display portion 221, and a store name is displayed at explanation display portion 222.

A selection menu corresponding to the monitoring screen is displayed at selection menu display portion 204. Sales-floor selection menu 224 is displayed at selection menu display portion 204 on the store comparison screen. If the user selects a sales floor on sales-floor selection menu 224, the area image in image-by-store list 223 is switched to the area image of the selected sales floor.

If the user performs a selection operation on any store on the store comparison screen, specifically, performs a selection operation on a store name in image-by-store list 223 displayed at image list display portion 205, the screen is transitioned to a sales-floor list checking screen (see FIG. 11).

The situation of each sales floor in the selected store is checked on the sales-floor list checking screen illustrated in FIG. 11. Image-by-sales-floor list 225 in which area images of all sales floors in the store selected on the store comparison screen (see FIG. 10) have been arranged along with sales-floor names is displayed at image list display portion 205 on the sales-floor list checking screen. The area image of each sales floor is displayed at area image display portion 221, and a sales-floor name is displayed at explanation display portion 222.

Store selection menu 226 is displayed at selection menu display portion 204 on the sales-floor list checking screen. All stores relating to a group to which the user belongs are displayed on store selection menu 226. If the user performs a selection operation on a store on store selection menu 226, the area image in image-by-sales-floor list 225 is switched to the area image of the selected store.

If the user selects a sales floor on the sales-floor list checking screen, specifically, performs a selection operation on a sales-floor name in image-by-sales-floor list 225 displayed at image list display portion 205, the screen is transitioned to a designated-time checking screen (see FIG. 12).

The designated-time checking screen illustrated in FIG. 12 is provided for performing comparison of a situation of the selected sales floor between days different from each other, by using the sales floor as a target. Image-by-day list 227 in which area images of the sales floor selected on the sales-floor list checking screen (see FIG. 11) for days in a predetermined period have been arranged at image list display portion 205 is displayed on the designated-time checking screen. The area image of each sales floor is displayed at area image display portion 221, and the store is displayed at explanation display portion 222. The date is displayed at date display portion 229 provided on the top.

The designated date and an area image at a predetermined display time point on each of predetermined days at a predetermined interval from the designated date are displayed on image-by-day list 227. In the example illustrated in FIG. 12, area images for four days including the designated date are displayed. Area images at the same display time point on the days are arranged and displayed side by side.

Display interval selection portion 206 for selecting an interval of a date to be displayed in image-by-day list 227 is provided on the designated-time checking screen.

Similar to the store comparison screen (see FIG. 10), sales-floor selection menu 224 is displayed at selection menu display portion 204 on the designated-time checking screen. If the user selects a sales floor on sales-floor selection menu 224, the area image in image-by-day list 227 is switched to the area image of the selected sales floor.

If the user selects a date on the designated-time checking screen, specifically, performs a selection operation on a date in image-by-day list 227 displayed at image list display portion 205, the screen is transitioned to a whole-day checking screen (see FIG. 13).

The situation of the sales floor at each time of the whole day on the selected date is checked on the whole-day checking screen. Image-by-time list 228 in which an area image at each time point on the date selected on the designated-time checking screen (see FIG. 12) has been arranged in time series is displayed at image list display portion 205 on the whole-day checking screen. An area image of each sales floor is displayed at area image display portion 221, and a time point is displayed at explanation display portion 222.

Display interval selection portion 207 for selecting an interval of a time point to be displayed in image-by-time list 228 is provided on the whole-day checking screen.

Similar to the store comparison screen (see FIG. 10), sales-floor selection menu 224 is displayed at selection menu display portion 204 on the whole-day checking screen. If the user selects a sales floor on sales-floor selection menu 224, the area image in image-by-time list 228 is switched to the area image of the selected sales floor.

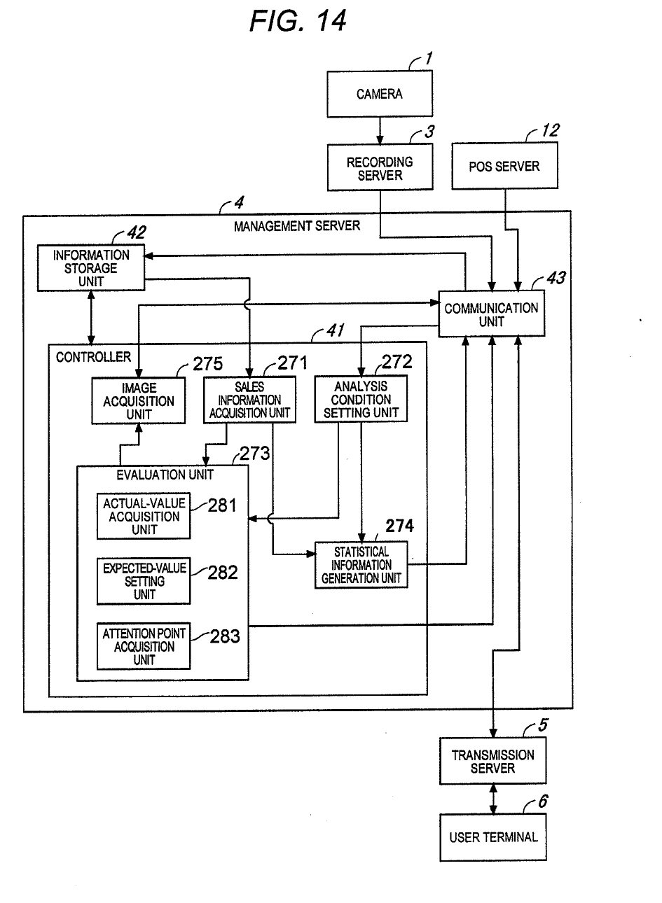

Next, a functional configuration of management server 4 will be described. FIG. 14 is a functional block diagram illustrating management server 4.

Controller 41 of management server 4 includes sales information acquisition unit 271, analysis condition setting unit 272, evaluation unit 273, statistical information generation unit 274, and image acquisition unit 75. The components of controller 41 are realized in a manner that the processor constituting controller 41 executes a program (instruction) for monitoring, which has been stored in information storage unit 42.

Sales information acquisition unit (accounting information acquisition unit) 271 acquires sales information (accounting information) which has been acquired from POS server 12 and accumulated in information storage unit 42. In the exemplary embodiment, the sales information acquisition unit can acquire at least one of a sales amount, a customer transaction, the number of customers, and a purchase rate, as the sales information. Here, the customer transaction means the payment amount per one customer (user). The number of customers (number of payers) means the number of persons (number of purchases) as customers performing accounting in the register counter. The purchase rate means the proportion of the sales amount of occupation of each purchased commodity type (type of used product or service) in the total sales amount.

The sales information also includes information regarding the sales budget, that is, information regarding the sales amount for achieving the sales day mark in the future period formulated in a sales plan. The sales information may be acquired from POS terminal 11.

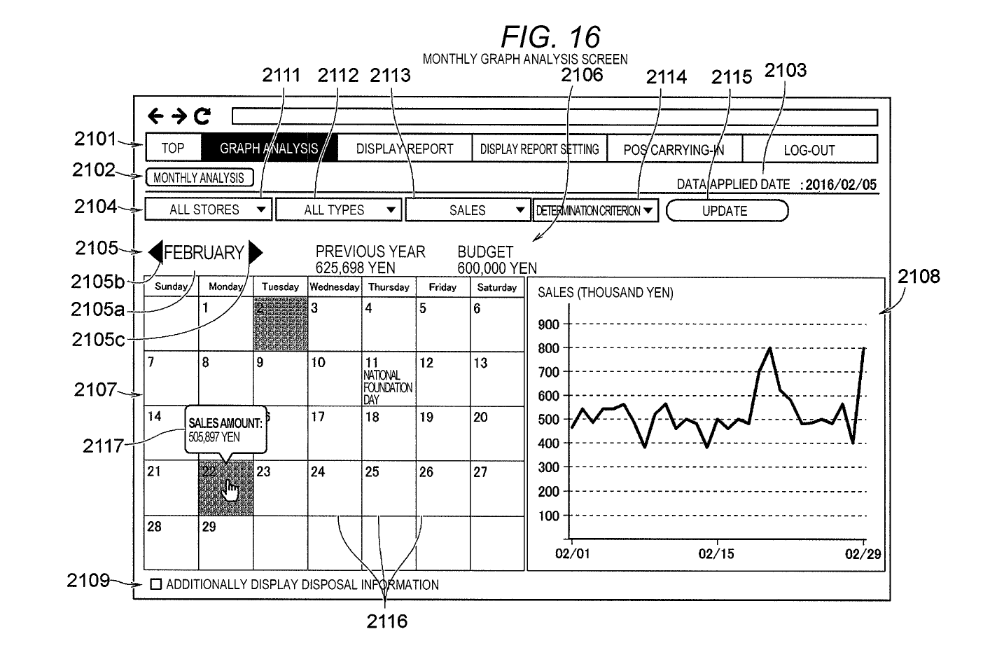

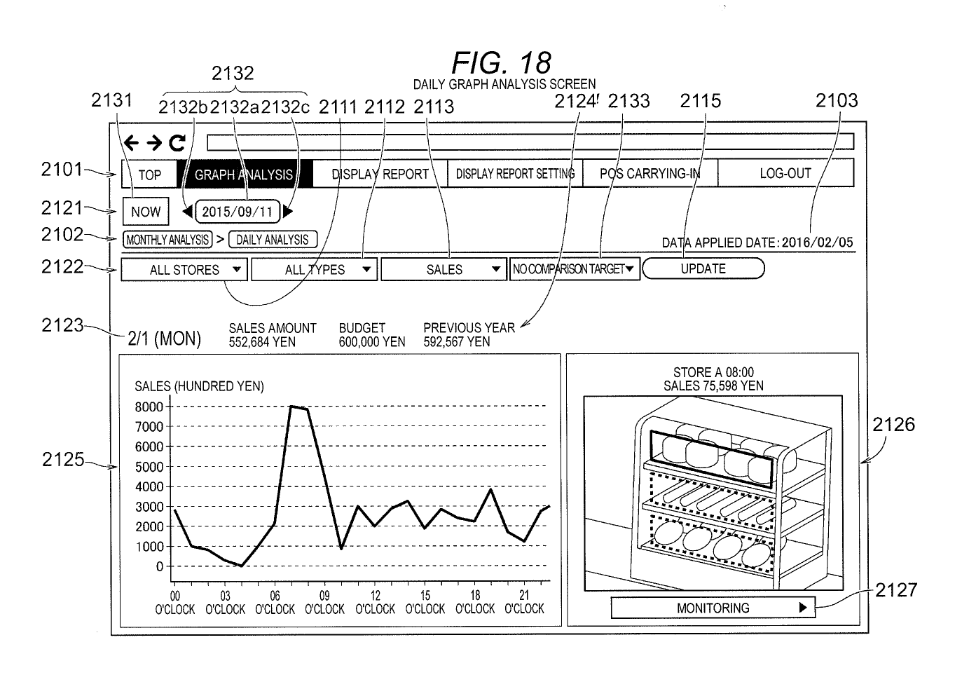

Analysis condition setting unit 272 sets an analysis condition used for evaluating a record for an operation situation of a store, in accordance with an operation input of the user. In the exemplary embodiment, a target period, a target store, and a target commodity type (sales floor) are set as the analysis condition. In addition, analysis indices (sales, customer transaction, number of customers, and purchase rate) are set, and determination criteria (budget, previous year, average of all stores, and average of previous 4 weeks) are set. In the exemplary embodiment, the analysis condition is designated on the monthly graph analysis screen (see FIG. 16) and the daily graph analysis screen (see FIG. 18) by the user.

Evaluation unit 273 evaluates a record for an operation situation of a store on each day in a target period (one month) based on the sales information acquired by sales information acquisition unit 71 and the analysis condition set by analysis condition setting unit 272. The evaluation unit acquires a date as an attention point in the target period, based on the evaluation result. Evaluation unit 273 includes actual-value acquisition unit 281, expected-value setting unit 282, and attention point acquisition unit 283.

Actual-value acquisition unit 281 performs statistical processing on the accounting information based on the analysis condition set by analysis condition setting unit 72. The actual-value acquisition unit acquires the actual value for the designated analysis index on each evaluation day in a target period by using the designated store and commodity type (sales floor) as targets.

Expected-value setting unit 282 performs statistical processing on the accounting information based on the analysis condition set by analysis condition setting unit 272. The expected-value setting unit acquires the expected value in the target period based on the designated determination criteria (budget, previous year, average of all stores, and average of previous four weeks). In the exemplary embodiment, at least one of a planned value of each store (in a case of budget), an actual value of each store (in a case of the previous year), an average value of the actual value of each store (in a case of the average of all stores), and an average value of the actual values on a plurality of designated dates in a predetermined period (in a case of the average of the previous four weeks) may be set as the expect value.

Attention point acquisition unit 283 compares the actual value on each evaluation day in the target period, which has been acquired by actual-value acquisition unit 281, to the expected value on the evaluation day, which has been set by expected-value setting unit 282, so as to determine a record on the evaluation day. The attention point acquisition unit selects the date to be the attention point.

Here, in the exemplary embodiment, any of the budget, the previous year, the average of all stores, and the average of the previous four weeks is allowed to be selected as the determination criterion.

The budget is used for performing an evaluation with the budget in this year as a reference. If the budget is selected, an aimed sales value (planned value) per one day, which has been appropriated for the budget in this year is set as the expected value. The actual value and the aimed sales value on each evaluation day in the target period are compared to each other, so as to evaluate the record on the evaluation day.

The previous year is used for performing an evaluation with the actual value on the same date in the previous year as the evaluation day, that is, the actual value on the same month and the same day as that of the evaluation day in the previous year, as a reference. If the previous year is selected, the actual value on the same date in the previous year is set as the expected value. Thus, the actual value on each evaluation day in the target period is compared to the actual value on the same date in the previous year so as to evaluate the record in each day.

The average of all stores is used for performing an evaluation with an all-store average value, that is, the average value of the actual values in all stores, as a reference. If the average of all stores is selected, the average value in the evaluation day in all stores is set as the expected value. Thus, the actual value in each evaluation day in the target period is compared to the average value in the same day in all the stores, so as to evaluate the record in each day.

The average of the previous four weeks is used for performing an evaluation with the average value for the previous four weeks from the evaluation day, as a reference. Here, the average value of the previous four weeks means the average value of the actual value for four days which are the same days of weeks in the previous (most recent) four weeks. For example, if March 29 is set as the evaluation day, the average value of the actual value on March 22 which is a date before one week, March 15 which is a date before two weeks, March 8 which is a date before three weeks, and March 1 which is a date before four weeks is obtained. If the average of the previous four weeks is selected, the average value in the evaluation day for the previous four weeks is set as the expected value. Thus, the actual value in each day in the target period is compared to the average value of the previous four weeks, so as to evaluate the record in each evaluation day.

In this manner, in the exemplary embodiment, the record in each evaluation day is evaluated. However, a day considered as particularly important, that is, a day on which a record is particularly low and a day on which a record is particularly high (specifically, a day on which a difference of the actual value and the expected value in the evaluation day is large) may be selected as an attention point. Thereby, the date to be set as the attention point may be narrowed. For example, the standard deviation σ of a set of actual values extracted in a required condition may be acquired. In a case where a difference between the actual value and the expected value in each evaluation day in the target period is greater than the standard deviation a, the date may be selected as the attention point.

Statistical information generation unit 274 generates statistical information based on the analysis condition set by analysis condition setting unit 272. In the exemplary embodiment, the actual value for the designated analysis index in each day is acquired for the designated target period (one month) by using a sales floor of the designated store as a target, as the statistical information. The actual value in each time slot on the designated day is acquired.

If an operation of selecting a comparison target on the daily graph analysis screen (see FIG. 18) is performed by the user, statistical information generation unit 274 generates statistical information regarding the comparison target. In the exemplary embodiment, the statistical information generation unit generates statistical information obtained by using all stores as a target, statistical information obtained by using four days which are the same days of weeks in the previous (most recent) four weeks as a target, and statistical information obtained by using any store as a target, as the statistical information regarding the comparison target.

Image acquisition unit 275 acquires an area image corresponding to the attention point acquired by evaluation unit 273, from a plurality of area images accumulated in recording server 3 (image accumulation unit). In the exemplary embodiment, the image acquisition unit acquires area images of a store and a sales floor which have been designated on the daily graph analysis screen (see FIG. 18) and acquires an area image in the time slot designated on the daily graph analysis screen.

In this manner, in management server 4, if the attention point and the area image are acquired, information regarding the acquired attention point and area image is transmitted to transmission server 5 (display information generation unit). In transmission server 5, display information regarding the monthly graph analysis screen (see FIG. 16) and the daily graph analysis screen (see FIG. 18) are generated based on the information acquired from management server 4, and the display information is transmitted to user terminal 6. Thus, the monthly graph analysis screen and the daily graph analysis screen are displayed in user terminal 6.

In particular, a calendar to be displayed on the monthly graph analysis screen is created based on the information acquired by evaluation unit 273. A monthly graph to be displayed on the monthly graph analysis screen and a daily graph to be displayed on the daily graph analysis screen are created based on the information acquired by statistical information generation unit 274. The area image acquired by image acquisition unit 275 is displayed on the daily graph analysis screen.

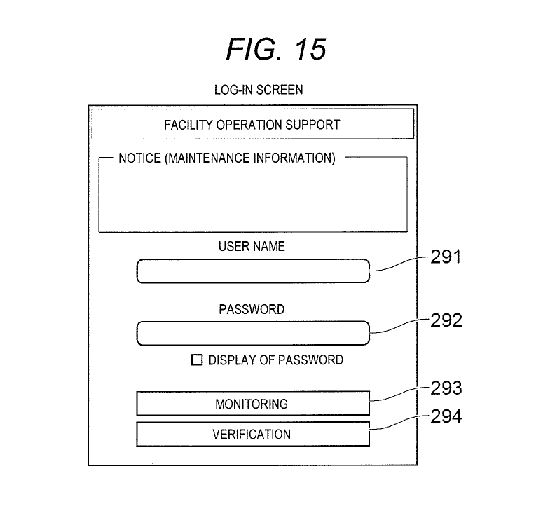

Next, the log-in screen displayed in user terminal 6 will be described. FIG. 15 is a diagram illustrating the log-in screen displayed in user terminal 6.

If user terminal 6 starts a Web browser to access transmission server 5, firstly, the log-in screen illustrated in FIG. 15 is displayed in the user terminal. In the exemplary embodiment, user authentication is performed with a user name and a password. Input portions 291 and 292 for a user name and a password are provided on the log-in screen.

In the exemplary embodiment, an authority for using a monitoring function and an authority for using a verification function are assigned to users different from each other. In a case using the monitoring function, log-in is performed by operating button 293 for “monitoring”. In a case using the verification function, log-in is performed by operating button 294 for “verification”.

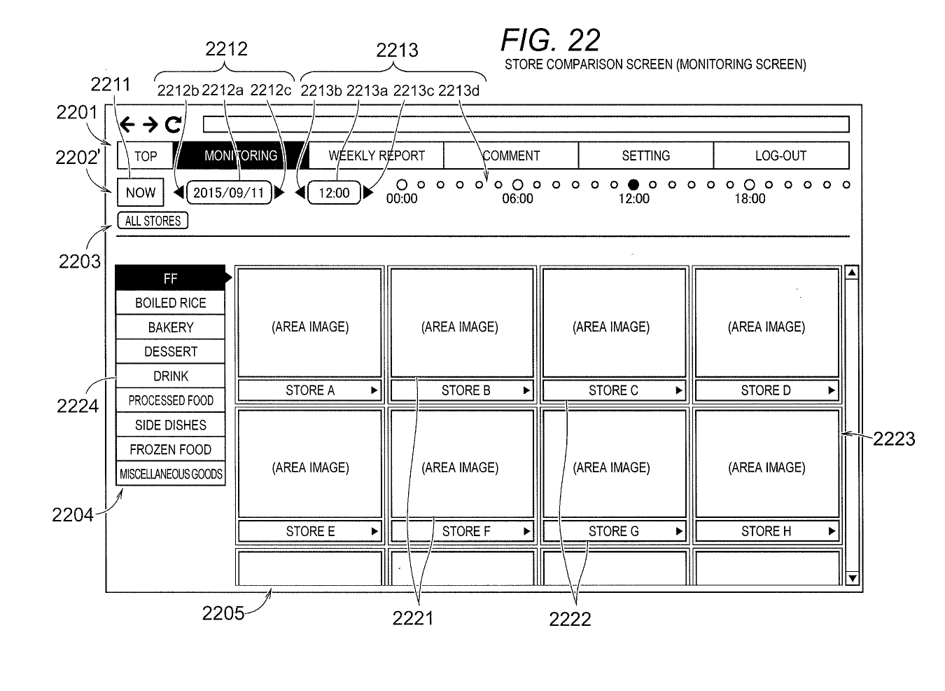

Here, if a user to which the authority for using the monitoring function has been assigned operates button 93 for monitoring and an attempt of user authentication succeeds, the screen is transitioned to the store comparison screen (see FIG. 22) which is the top screen for the monitoring function. If a user to which the authority for using the verification function has been assigned operates button 94 for verification and an attempt of user authentication succeeds, the screen is transitioned to the monthly graph analysis screen (see FIG. 16) which is the top screen for the verification function.

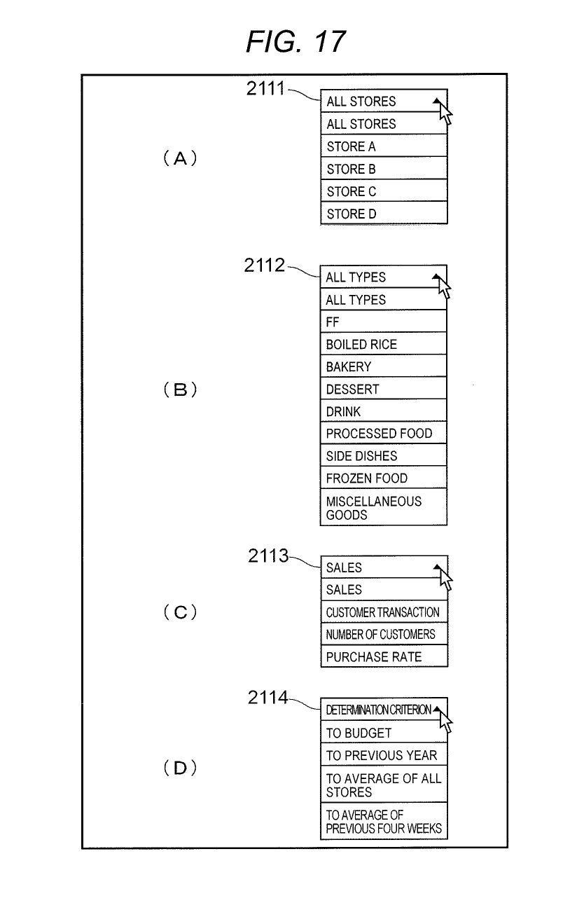

Next, the monthly graph analysis screen displayed in user terminal 6 will be described. FIG. 16 is a diagram illustrating the monthly graph analysis screen displayed in user terminal 6. FIG. 17 is a diagram illustrating a selection menu for an analysis condition on the monthly analysis screen.

The monthly graph analysis screen illustrated in FIG. 16 is provided for presenting a calendar (seven-day table) on which a date as the attention point in a target period (one month) designated by the user is shown, and a graph representing a transition situation of statistical information in the target period, to the user.

Main menu 2101, site map display portion 2102, data-applied date display portion 2103, analysis condition designation portion 2104, target-month display change portion 2105, monthly statistical information display portion 2106, calendar display portion 2107, graph display portion 108, and disposal-information addition designation portion 109 are provided on the monthly graph analysis screen.

In main menu 2101, any of the top, graph analysis, a display report, a display report setting, POS carrying-in, and log-out is allowed to be selected by a selection operation (clicking or tapping).

If the top is selected in main menu 2101, the screen is transitioned to the monthly graph analysis screen (see FIG. 16) which is the top screen for the verification function. If the graph analysis is selected on main menu 2101, the screen is transitioned to the monthly graph analysis screen (see FIG. 16). If the display report is selected on main menu 2101, the screen is transitioned to the display report screen (not illustrated). If the display report setting is selected on main menu 2101, the screen is transitioned to the display report setting screen (not illustrated). If the POS carrying-in is selected on main menu 2101, the screen is transitioned to the POS carrying-in screen (see FIG. 21). If the log-out is selected in main menu 2101, the screen in the process of being displayed is closed, and the screen is brought back to the log-in screen (see FIG. 15).

The display report screen is provided for presenting a result obtained by evaluating a display state of a commodity in a display area (display stand and the like) in a store, to the user. The display report setting screen is provided for causing the user to designate the analysis condition for evaluating the display state of a commodity.

Site map display portion 2102 is used for displaying a transition situation of the screen. A button of “monthly analysis” is displayed at site map display portion 2102, in a state where the monthly graph analysis screen is being displayed.

The data-applied date, that is, the date (last information collection day) of the carried-in sales information is displayed at data-applied date display portion 2103.

Analysis condition designation portion 2104 is provided for causing the user to designate the analysis condition for evaluating a record on each day in a target period (one month). Store selection portion 2111, commodity type selection portion 2112, analysis index selection portion 2113, determination criterion selection portion 2114, and update button 2115 are provided at analysis condition designation portion 2104.

Store selection portion 2111 is provided for causing the user to select a store as an analysis target. If the user operates store selection portion 2111, the store selection menu (list box) is displayed as illustrated in FIG. 17(A). All stores meaning all stores as a target and each store is allowed to be selected on the store selection menu. Here, if all stores are selected, all the stores are set as the analysis target. If each store is selected, the selected store is set as the analysis target.

Commodity type selection portion 2112 is provided for causing the user to select a commodity type as the analysis target. If the user operates commodity type selection portion 2112, a commodity type selection menu (list box) is displayed as illustrated in FIG. 17(B). All types meaning all commodity types as a target and each commodity type such as fast food (FF) or boiled rice is allowed to be selected on the commodity type selection menu. Here, if all types are selected, all the commodity types are set as an analysis target. If each commodity type is selected, the selected commodity type is set as an analysis target.

Analysis index selection portion 2113 is provided for causing the user to select an analysis index. If the user operates analysis index selection portion 2113, an analysis index selection menu (list box) is displayed as illustrated in FIG. 17(C). Analysis indices of sales, a customer transaction, the number of customers, and a purchase rate are allowed to be selected on the analysis index selection menu.

In the exemplary embodiment, the sales, the customer transaction, the number of customers, or the purchase rate allowed to be acquired from sales information acquired from the POS system is selected as the analysis index. In addition, camera detection information, that is, information detected by performing an image analysis on a captured image, for example, the number of visitors, the number of persons staying at each display area, the display quantity, the face-up degree, the alignment degree, the volume degree, and the stockout continuity degree may be allowed to be selected as the analysis index.

Determination criterion selection portion 2114 is provided for causing the user to select a determination criterion used for evaluating the record in each day. If the user operates determination criterion selection portion 2114, a determination criterion selection menu (list box) is displayed as illustrated in FIG. 17(D). The determination criteria of the budget, the previous year, the average of all stores, and the average of the previous four weeks are allowed to be selected on the determination criterion selection menu.

If analysis conditions are designated by performing a selection operation on store selection portion 2111, commodity type selection portion 2112, analysis index selection portion 2113, and determination criterion selection portion 2114 in analysis condition designation portion 2104, and update button 2115 is operated, an evaluation is performed based on the designated analysis condition, and the evaluation result is displayed at calendar display portion 2107.

Target month display portion 2105a, leftward arrow button 2105b, rightward arrow button 2105c are provided at target-month display change portion 2105. A target month being currently set is displayed at target month display portion 2105a. Arrow buttons 2105b and 2105c perform monthly feeding. If the user operates leftward arrow button 2105b, the display month is changed to the previous month. If the user operates rightward arrow button 2105c, the display month is changed to the next month.

Sales (daily average) in the same month (month which is the same as the target month) in the previous year and budget (aimed sales value) in the target month in this year are displayed at monthly statistical information display portion 2106. Regarding the sales in the previous year and the budget in this year, designated contents at store selection portion 2111 and commodity type selection portion 2112 of analysis condition designation portion 2104 are applied. For example, if all stores are selected at store selection portion 2111, statistical information obtained by using all the stores as a target is displayed. If any store is selected at store selection portion 2111, statistical information obtained by using the selected store as a target is displayed. If all types are selected at commodity type selection portion 2112, statistical information obtained by using all the commodity types as a target is displayed. If any commodity type is selected at commodity type selection portion 2112, statistical information obtained by using the selected commodity type as a target is displayed.

A calendar in which cells 2116 for dates are arranged side by side on a weekly basis is displayed at calendar display portion 2107. In the exemplary embodiment, the record for an operation situation of a store for days in one month is evaluated based on the analysis condition designated at analysis condition designation portion 2104, that is, the store (all stores or each store), the commodity type (all commodity types or each commodity type), the analysis indices (sales, customer transaction, number of customers, and purchase rate), and the determination criteria (budget, previous year, average of all stores, and average of the previous four weeks). Then, the evaluation result in each day is displayed in cell 2116 corresponding to this day. In particular, in the exemplary embodiment, the evaluation result in each day is expressed by the color with which cell 2116 is filled. For example, a day having a high record is displayed with a green color, and a day having a low record is displayed with a red color.

If an operation of selecting cell 2116 for a date is selected at calendar display portion 2107, specifically, an operation (on-cursor) of putting a cursor on cell 2116 is performed, pop-up display of message box 2117 is performed. Numerical values of the selected date, which relate to the analysis indices (sales, customer transaction, number of customers, and purchase rate) selected at analysis index selection portion 2113 are displayed in the message box.

If an operation of selecting cell 2116 for a date is selected at calendar display portion 2107, specifically, an operation of putting and clicking the cursor on cell 2116 is performed, the screen is transitioned to the daily graph analysis screen (see FIG. 18). At this time, analysis information obtained by using a date corresponding to cell 2116 operated on the monthly graph analysis screen is displayed on the daily graph analysis screen.

Disposal-information addition designation portion 2109 is provided for selecting whether or not to perform an evaluation in which an evaluation result for disposal information has been additionally provided. If a check mark is put into a check box, the evaluation in which an evaluation result for disposal information has been additionally provided is performed. The evaluation result is displayed at calendar display portion 2107. At this time, an evaluation for each day is performed based on statistical information regarding the analysis indices (sales, customer transaction, number of customers, and purchase rate) selected at analysis index selection portion 2113 and disposal information. The evaluation result for each day is displayed in cell 2116 in calendar display portion 2107, which corresponds to the date. An evaluation for the analysis index selected at analysis index selection portion 2113 and an evaluation regarding disposal information may be separately performed. Evaluation results may be aggregated (subjected to statistical processing) so as to acquire one evaluation result.

The evaluation result regarding the analysis index selected at analysis index selection portion 2113 and the evaluation result regarding the disposal information may be separately displayed at calendar display portion 2107. In this case, for example, cell 2116 for each day may be divided into an upper part and a lower part. The upper half of cell 2116 may be filled with a color indicating the evaluation result for the analysis index selected at the analysis index selection portion. The lower half of cell 2116 may be filled with a color indicating the evaluation result of the disposal information.

A graph representing a transition situation of statistical information of each day in one month is displayed at graph display portion 2108. In the graph, a horizontal axis indicates a time slot, and a vertical axis indicates statistical information. The graph corresponds to statistical information based on the analysis condition designated at analysis condition designation portion 2104, that is, the store (all stores or each store), the commodity type (all commodity types or each commodity type), the analysis indices (sales, customer transaction, number of customers, and purchase rate). For example, if all stores are selected at store selection portion 2111, all types are selected at commodity type selection portion 2112, and the sales is selected at analysis index selection portion 2113, sales amounts obtained by using all commodity types in all the stores as a target are aggregated for each one day, and thus a graph representing the sales for each day is created.

If an operation (on-cursor) of putting a cursor at a position on the graph, which corresponds to a day is performed at graph display portion 2108, pop-up display of a message box (not illustrated) is performed. The date and statistical information are displayed in the message box.

If any of the budget, the previous year, the average of all stores, and the average of the previous four weeks is selected at determination criterion selection portion 2114 as the determination criterion, a graph for the determination criterion is displayed at graph display portion 2108 along with the graph for an analysis target designated at store selection portion 2111, commodity type selection portion 2112, and analysis index selection portion 2113. Thus, the graph for the analysis target is compared to the graph for the determination criterion, and thus it is possible that the user grasps the operation situation of the store in the target period.

For example, if the budget is selected at determination criterion selection portion 2114, a graph for an aimed sales value per one day, which has been appropriated for the budget in this year is displayed as the graph for the determination criterion. If the previous year is selected, a graph for the actual value on the same date in the previous year is displayed as the graph for the determination criterion. If the average of all stores is selected, a graph for the all-store average value, that is, the average value of the actual values in all the stores is displayed. If the average of the previous four weeks is selected, four graphs for the average value for the previous four weeks, that is, actual values for four days which are the same days of weeks in the previous (most recent) four weeks are displayed. One graph for the average value of the actual values for four days may be displayed.

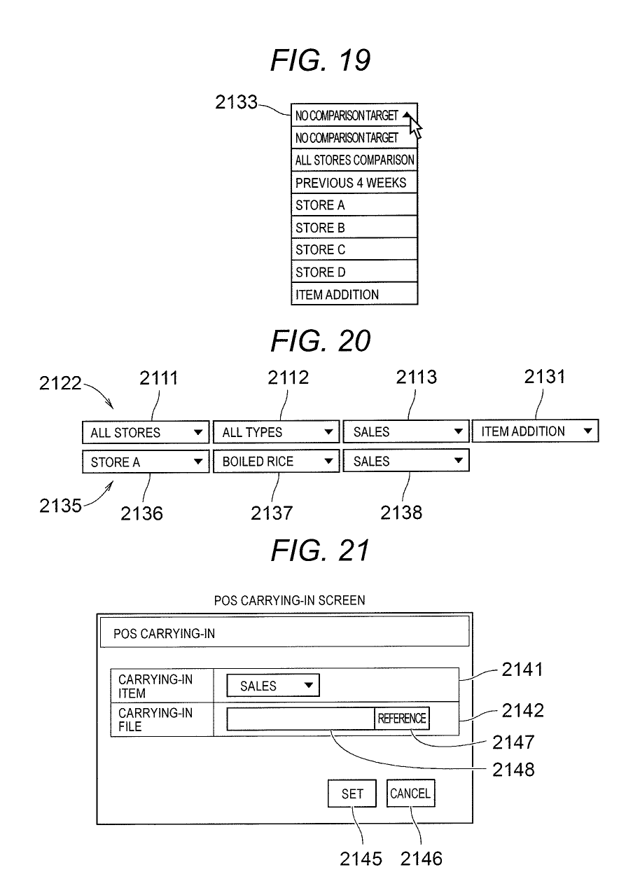

Next, the daily graph analysis screen displayed in user terminal 6 will be described. FIG. 18 is a diagram illustrating the daily graph analysis screen displayed in user terminal 6. FIG. 19 is a diagram illustrating a selection menu for a comparison target on the daily analysis screen. FIG. 20 is a diagram illustrating the daily graph analysis screen when an item addition has been selected.

The daily graph analysis screen illustrated in FIG. 18 is provided for presenting a graph indicating a transition situation of statistical information on a target date designated by the user and an area image on the target date, to the user. The daily graph analysis screen is displayed by selecting cell 2116 for a day at calendar display portion 2107 on the monthly graph analysis screen (see FIG. 16). A graph and an area image on the date selected on the monthly graph analysis screen are displayed on the daily graph analysis screen.

Main menu 2101, date designation portion 2121, site map display portion 2102, analysis condition designation portion 2122, target day display portion 2123, daily statistical information display portion 2124, graph display portion 2125, area image display portion 2126, and button 2127 of “monitoring” are provided on the daily graph analysis screen.

Main menu 2101 and site map display portion 2102 are similar to those on the monthly graph analysis screen (see FIG. 16). In a state where the daily graph analysis screen is being displayed, buttons of “monthly analysis” and “daily analysis” are displayed at site map display portion 2102. If the button of “monthly analysis” is operated, the screen can be brought back to the monthly graph analysis screen.

Date designation portion 121 is provided for designating a date for displaying a graph at graph display portion 2125 and an area image at area image display portion 2126. NOW button 2131 and date change portion 2132 are provided at date designation portion 2121.

If the user operates NOW button 2131, a graph representing statistical information for today is displayed at graph display portion 2125, and the current area image is displayed at area image display portion 2126. Thus, in a case where the user wants to check the current situation after having checked the previous situation, the current situation can be rapidly displayed.

Date display portion 2132a, leftward arrow button 2132b, and rightward arrow button 2132c are provided at date change portion 2132. A date being currently set is displayed at date display portion 2132a. If the user operates date display portion 2132a, the calendar screen (not illustrated) is displayed, and the date is allowed to be selected on the calendar screen. Arrow buttons 2132b and 2132c perform daily feeding. If the user operates leftward arrow button 2132b, the display date is changed to a day before one day. If the user operates rightward arrow button 2132c, the display date is changed to a day after one day.

Similar to the monthly graph analysis screen (see FIG. 16), analysis condition designation portion 2122 is provided for causing the user to designate the analysis condition. Store selection portion 2111, commodity type selection portion 2112, analysis index selection portion 2113, comparison target selection portion 2133, and update button 2115 are provided at analysis condition designation portion 2122. Store selection portion 2111, commodity type selection portion 2112, analysis index selection portion 2113, and update button 2115 are similar to those on the monthly graph analysis screen. Contents designated on the monthly graph analysis screen are inherited at store selection portion 2111, commodity type selection portion 2112, and analysis index selection portion 2113.

A date as a target day is displayed at target day display portion 2123. In an initial state transitioned from the monthly graph analysis screen (see FIG. 16), the date selected on the monthly graph analysis screen is displayed. In a case where the date is changed and designated at date designation portion 2121, the designated date is displayed.

Sales on the target date, budget (aimed sales value) on the target date, and sales on a date in the previous year, which is the same as the target date are displayed as daily statistical information, at daily statistical information display portion 2124. Regarding the statistical information, the contents designated at store selection portion 2111 and commodity type selection portion 2112 are applied. That is, if all stores are selected at store selection portion 2111, statistical information obtained by using all the stores as a target is displayed. If any store is selected at store selection portion 2111, statistical information obtained by using the selected store as a target is displayed. If all types are selected at commodity type selection portion 2112, statistical information obtained by using all the commodity types as a target. If any commodity type is selected at commodity type selection portion 2112, statistical information obtained by using the selected commodity type as a target is displayed.

A graph representing a transition situation of statistical information for each time slot in one day is displayed at graph display portion 2125. In the graph, a horizontal axis indicates a time slot, and a vertical axis indicates statistical information. The graph corresponds to statistical information based on the analysis condition designated at analysis condition designation portion 2122, that is, the store (all stores or each store), the commodity type (all commodity types or each commodity type), the analysis indices (sales, customer transaction, number of customers, and purchase rate). For example, if all stores are selected at store selection portion 2111, all types are selected at commodity type selection portion 2112, and the sales is selected at analysis index selection portion 2113, sales amounts obtained by using all commodity types in all the stores as a target are aggregated for each time slot, and thus a graph representing the sales for each time slot is created.

If an operation (on-cursor) of putting a cursor at a position on the graph, which corresponds to a time slot is performed at graph display portion 2125, pop-up display of a message box is performed. A time slot and statistical information in the time slot are displayed in the message box.

Comparison target selection portion 2133 is provided for causing the user to select a comparison target. If the user selects a comparison target at comparison target selection portion 2133, a graph for the comparison target is additionally displayed at graph display portion 2125. That is, the graph for the comparison target is displayed along with the graph for the analysis target based on selection contents at store selection portion 2111, commodity type selection portion 2112, and analysis index selection portion 2113 in analysis condition designation portion 2122. Thus, the graph for the analysis target is compared to the graph for the comparison target, and thus it is possible that the user grasps the operation situation of the store for each time slot.

If the user operates comparison target selection portion 2133, a comparison target selection menu (list box) is displayed as illustrated in FIG. 19. Any of no comparison target, all-store comparison, the previous four weeks, each store, and an item addition is allowed to be selected on the comparison target selection menu.

If no comparison target is selected at comparison target selection portion 2133, the comparison target is not set.

If all-store comparison is selected at comparison target selection portion 2133, actual values of all stores as a target, that is, the average value of the actual value for all stores is set as the comparison target, and a graph for the comparison target is displayed. If previous four weeks is selected, actual values for four days which are the same days of weeks in the previous (most recent) four weeks are set as comparison targets, and graphs for the four comparison targets are displayed. The average value of the actual values for the four days may be set as the comparison target, and one graph may be displayed. If any store is selected, an actual value of the selected store is set as the comparison target, and the graph for the comparison target is displayed.

If item addition is selected at comparison target selection portion 2133, as illustrated in FIG. 20, analysis condition designation portion 2135 for the comparison target can be added under analysis condition designation portion 2122 for the analysis target. Statistical information based on an analysis condition which is different from the analysis condition (store, commodity type, or analysis index) designated at analysis condition designation portion 2122 can be set as the comparison target. A graph for the comparison target set here is displayed at graph display portion 2125.

Similarly to analysis condition designation portion 122 for the analysis target, store selection portion 2136, commodity type selection portion 2137, and analysis index selection portion 2138 are provided at analysis condition designation portion 2135 for the comparison target.

Store selection portion 2136 is provided for causing the user to select a store for the comparison target. If the user operates store selection portion 2136, a store selection menu which is substantially similar to the store selection menu illustrated in FIG. 17(A) is displayed. A store is allowed to be selected on the store selection menu. However, all stores meaning all stores as a target are excluded from the store selection menu, and thus selection of all stores is not possible.

Commodity type selection portion 2137 is provided for causing the user to select a commodity type for the comparison target. If the user operates commodity type selection portion 2137, a commodity type selection menu which is substantially similar to the commodity type selection menu illustrated in FIG. 17(B) is displayed. A commodity type such as fast food (FF) or boiled rice is allowed to be selected on the commodity type selection menu. However, all types meaning all commodity types as a target are excluded from the commodity type selection menu, and thus selection of all types is not possible.

Analysis index selection portion 2138 is provided for causing the user to select an analysis index for the comparison target. If the user operates the analysis index selection portion, an analysis index selection menu which is substantially similar to the analysis index selection menu illustrated in FIG. 17(C) is displayed. An analysis index such as the sales, the customer transaction, the number of customers, or the purchase rate is allowed to be selected on the analysis index selection menu.

In a case where an analysis index which is different from that at analysis index selection portion 2113 has been selected at analysis index selection portion 2138, the graph for the analysis target is different from the graph for the comparison target. Thus, a two-axis graph in which two vertical axes are set on the left and right may be provided.

An area image of a sales floor, which corresponds to the store selected at store selection portion 2111 and the commodity type selected at commodity type selection portion 2112 is displayed at area image display portion 2126. The name of the store, a capturing time point of the area image, and statistical information in a time slot in the area image are displayed at area image display portion 2126. If a time slot is selected at graph display portion 2125, that is, the position corresponding to the time slot on the graph is operated (clicked), an area image in the time slot is displayed. The area image to be displayed has been obtained on the hour in the selected time slot.

Here, in a case where all types have been selected at commodity type selection portion 2112, an area image of the sales floor, which corresponds to a commodity type having the smallest type ID is displayed. Since the type ID is assigned in descending order of importance, the area image of a commodity type having the highest importance, for example, fast food (FF) is displayed.

In the example illustrated in FIG. 18, one area image corresponding to the store and the commodity type set as the target is displayed. However, in a case where a comparison target has been set, an area image corresponding to a store and a commodity type set as the comparison target may be displayed side by side.

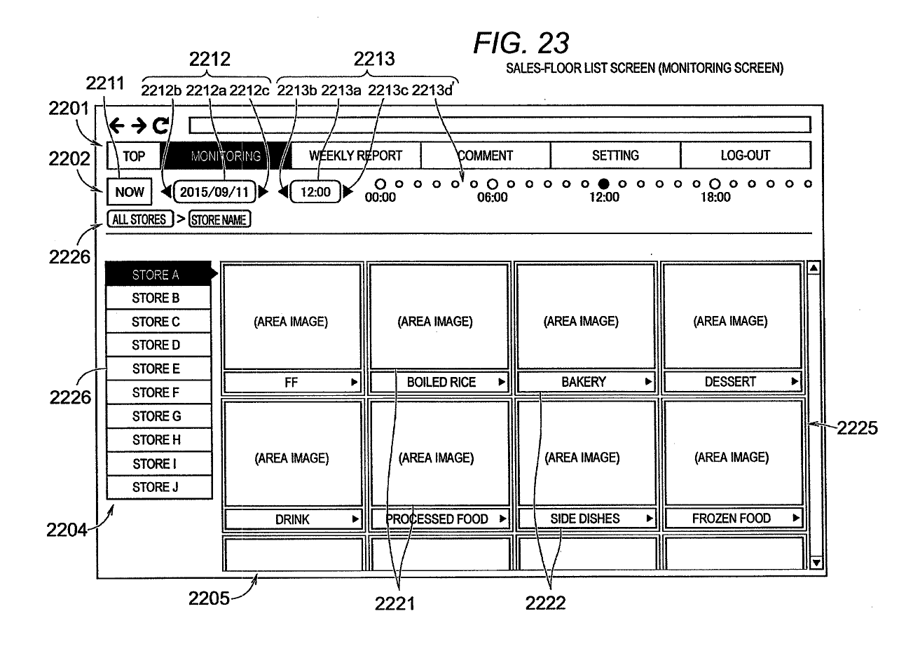

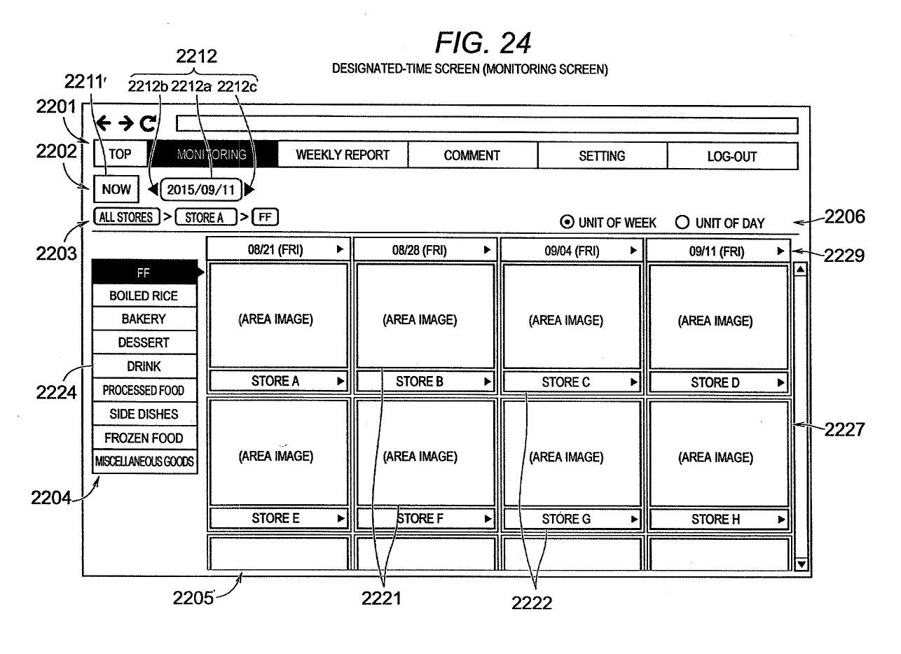

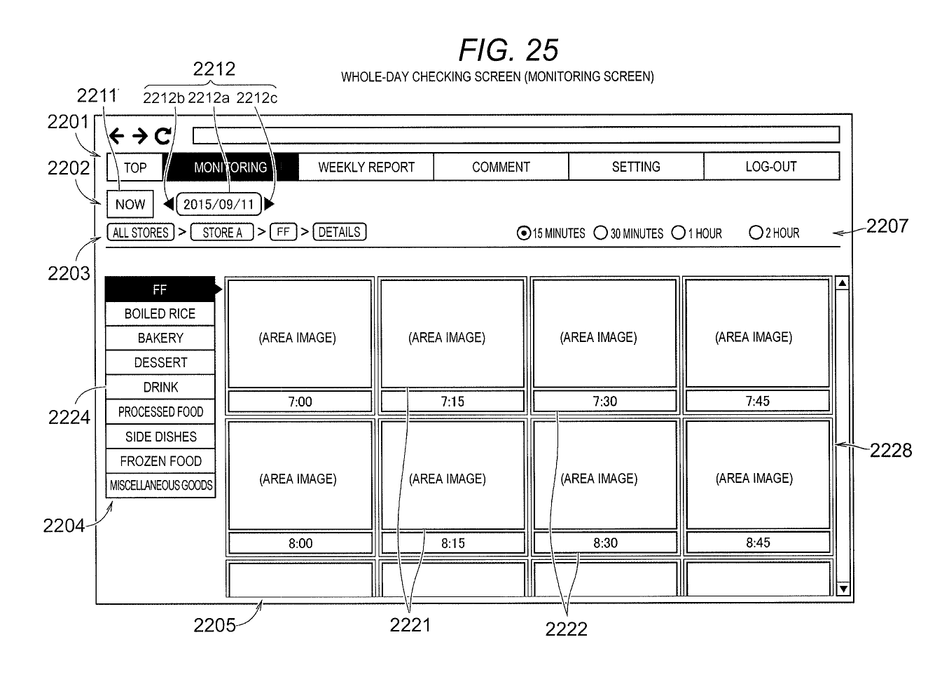

If the user operates button 2127 of “monitoring”, the screen is transitioned to a monitoring screen (store comparison screen (see FIG. 22), sales-floor list screen (see FIG. 23), designated-time screen (see FIG. 24), or whole-day checking screen (see FIG. 25)). The monitoring screen as a transition destination will be described later in detail.

Next, a POS carrying-in screen displayed in user terminal 6 will be described. FIG. 21 is a diagram illustrating the POS carrying-in screen displayed in user terminal 6.

The POS carrying-in screen is provided for carrying sales information managed by the POS system in. The sales information is stored in a file having a comma-separated values (CSV) format, for example. The sales information is carried in by designating this file.

Carrying-in item selection portion 2141, carrying-in file selection portion 2142, set button 2145, and cancel button 2146 are provided on the POS carrying-in screen.

A carrying-in item is selected at carrying-in item selection portion 2141 by the user. If the user operates carrying-in item selection portion 2141, a carrying-in item selection menu is displayed. In the exemplary embodiment, a carrying-in item is set for each analysis index (sales, customer transaction, number of customers, and purchase rate). The sales, the customer transaction, the number of customers, or the purchase rate is allowed to be selected as the carrying-in item, on the carrying-in item selection menu.

File name display portion 2147 and reference button 2148 are provided at carrying-in file selection portion 2142. If the user operates reference button 2148, a file selection screen is displayed. If a file is selected on the file selection screen, the file name is displayed at file name display portion 2147.

If the user operates set button 2145, sales information is carried in based on contents input at carrying-in item selection portion 2141 and carrying-in file selection portion 2142, and the POS carrying-in screen is closed. If the user operates cancel button 2146, the POS carrying-in screen is closed without carrying the sales information in.

Next, the monitoring screen (store comparison screen, sales-floor list screen, designated-time screen, and whole-day checking screen) displayed in user terminal 6 will be described. FIG. 22 is a diagram illustrating the store comparison screen displayed in user terminal 6. FIG. 23 is a diagram illustrating the sales-floor list screen displayed in user terminal 6. FIG. 24 is a diagram illustrating the designated-time screen displayed in user terminal 6. FIG. 25 is a diagram illustrating the whole-day checking screen displayed in user terminal 6.

If the user operates button 293 of monitoring on the log-in screen (see FIG. 15), the screen is transitioned to the store comparison screen which is the top screen for the monitoring function and is illustrated in FIG. 22.

The store comparison screen is provided for performing comparison of a situation of the common sales floor between the stores, by using the common sales floor as a target. Main menu 2201, date designation portion 2202, site map display portion 2203, selection menu display portion 2204, and image list display portion 2205 are provided on the store comparison screen.

In main menu 2201, any of the top, monitoring, a weekly report, a comment, setting, and log-out is allowed to be selected by a selection operation (clicking or tapping).

If the top is selected in main menu 2201, the screen is transitioned to the store comparison screen (see FIG. 22) which is the top screen for the monitoring function. If the monitoring is selected in main menu 2201, the screen is transitioned to the store comparison screen as the top screen of the monitoring screen.

If the weekly report is selected in main menu 2201, a sub-menu is displayed. With a selection operation of the sub-menu, the screen is transitioned to a weekly-report list screen (not illustrated) or a weekly-report detail screen (not illustrated). The weekly-report list screen is used for causing a manager or a store manager to check the situation of each store in a weekly report (report in response to a weekly instruction). The weekly-report detail screen (not illustrated) is used for causing a store manager to perform a weekly report and causing a manager to check the weekly report input by the store manager.

If the comment is selected in main menu 2201, a sub-menu is displayed. With a selection operation of the sub-menu, the screen is transitioned to a comment list screen (not illustrated) or a comment setting screen (not illustrated). The comment list screen (not illustrated) is used for display a list of a comment of which a designated person such as a store manager is notified at an appropriate timing by a manager. The comment setting screen (not illustrated) is used for inputting a new comment.

If the setting is selected in main menu 2201, a sub-menu is displayed. With a selection operation of the sub-menu, the screen is transitioned to a user setting screen (not illustrated), a topic setting screen (not illustrated), or a password change screen (not illustrated). The user setting screen (not illustrated) is used for designating various user setting items. The topic setting screen is used for inputting a topic of which store managers of all stores are notified at once by a manager.

If the log-out is selected in main menu 2201, the screen which is in the process of being displayed and relates to the monitoring function is closed, and the screen is brought back to the log-in screen (see FIG. 15).

Date designation portion 2202 is used for designating the display date and time of the area image at image list display portion 2205. An area image for the designated date and time is displayed at image list display portion 205. NOW button 2211, date change portion 2212, and time-point change portion 2213 are provided at date designation portion 2202.

If the user operates NOW button 2211, an area image at the current time point (the latest image acquisition time point) is displayed at image list display portion 2205.

Date display portion 2212a, leftward arrow button 2212b, and rightward arrow button 2212c are provided at the date change portion 2212. If the user operates date display portion 2212a, the calendar screen (not illustrated) is displayed, and the date is allowed to be selected on the calendar screen. Arrow buttons 2212b and 2212c perform daily feeding. If the user operates leftward arrow button 2212b, the display date and time is changed to a day before one day. If the user operates rightward arrow button 2212c, the display date and time is changed to a day after one day.

Time-point display portion 2213a, leftward arrow button 2213b, rightward arrow button 213c, and time bar 2213d are provided at time-point change portion 2213. Arrow buttons 2213b and 2213c perform time feeding corresponding to a timing (for example, an interval of 15 minutes) of image acquisition. If the user operates leftward arrow button 2213b, the display time point is changed to a time point (for example, before 15 minutes) corresponding to a timing before one interval. If the user operates rightward arrow button 2213c, the display time point is changed to a time point (for example, after 15 minutes) corresponding to a timing after one interval.

Time bar 2213d is used for selecting a time slot in the operation time. If a point indicating a time slot is selected, the time is changed to a time point indicating the selected point.

Site map display portion 2203 is provided for displaying a transition situation of the screen. Buttons of “all stores”, “store name”, “sales-floor name”, and “details” are displayed at site map display portion 2203 in accordance with the monitoring screen (see FIGS. 22 to 25). If the user operates the button, the screen is transitioned to the corresponding monitoring screen.

A plurality of area image display portions 2221 arranged vertically and horizontally, and explanation display portions 2222 which are respectively disposed under area image display portions 2221 are provided at image list display portion 2205. In particular, image-by-store list 2223 in which an area image of each store, which relates to the common sales floor has been arranged along with the store name is displayed at image list display portion 2205 on the store comparison screen. An area image of each store is displayed at area image display portion 2221, and a store name is displayed at explanation display portion 2222.

A selection menu corresponding to the monitoring screen is displayed at selection menu display portion 2204. Sales-floor selection menu 2224 is displayed at selection menu display portion 2204 on the store comparison screen. If the user selects a sales floor on the sales-floor selection menu 2224, the area image in image-by-store list 2223 is switched to the area image of the selected sales floor.

If the user performs a selection operation on any store on the store comparison screen, specifically, performs a selection operation on a store name in image-by-store list 2223 displayed at image list display portion 2205, the screen is transitioned to a sales-floor list checking screen (see FIG. 23).

The situation of each sales floor in the selected store is checked on the sales-floor list checking screen illustrated in FIG. 23. Image-by-sales-floor list 2225 in which area images of all sales floors in the store selected on the store comparison screen (see FIG. 22) have been arranged along with sales-floor names is displayed at image list display portion 2205 on the sales-floor list checking screen. An area image of each sales floor is displayed at area image display portion 2221, and a sales-floor name is displayed at explanation display portion 2222.

Store selection menu 2226 is displayed at selection menu display portion 2204 on the sales-floor list checking screen. All stores relating to a group to which the user belongs are displayed on store selection menu 2226. If the user performs a selection operation on a store on store selection menu 2226, the area image in the image-by-sales-floor list 2225 is switched to the area image of the selected store.

If the user selects a sales floor on the sales-floor list checking screen, specifically, performs a selection operation on a sales-floor name in the image-by-sales-floor list 2225 displayed at image list display portion 2205, the screen is transitioned to a designated-time checking screen (see FIG. 24).

The designated-time checking screen illustrated in FIG. 24 is provided for performing comparison of a situation of the selected sales floor between days different from each other, by using the sales floor as a target. Image-by-day list 2227 in which area images of the sales floor selected on the sales-floor list checking screen (see FIG. 23) for days in a predetermined period have been arranged at image list display portion 2205 is displayed on the designated-time checking screen. An area image of each sales floor is displayed at area image display portion 2221, and a store is displayed at explanation display portion 222. The date is displayed at date display portion 2229 provided on the top.

The designated date and an area image at a predetermined display time point on each of predetermined days at a predetermined interval from the designated date are displayed on image-by-day list 2227. In the example illustrated in FIG. 24, area images for four days including the designated date are displayed. Area images at the same display time point on the days are arranged and displayed side by side.

Display interval selection portion 2206 for selecting an interval of a date to be displayed in image-by-day list 2227 is provided on the designated-time checking screen.

Similar to the store comparison screen (see FIG. 22), sales-floor selection menu 2224 is displayed at selection menu display portion 2204 on the designated-time checking screen. If the user selects a sales floor on sales-floor selection menu 2224, the area image in image-by-day list 2227 is switched to the area image of the selected sales floor.

If the user selects a date on the designated-time checking screen, specifically, performs a selection operation on a date in image-by-day list 2227 displayed at image list display portion 2205, the screen is transitioned to a whole-day checking screen (see FIG. 25).

The situation of the sales floor at each time of the whole day on the selected date is checked on the whole-day checking screen illustrated in FIG. 25. Image-by-time list 2228 in which an area image at each time point on the date selected on the designated-time checking screen (see FIG. 24) has been arranged in time series is displayed at image list display portion 2205 on the whole-day checking screen. An area image of each sales floor is displayed at area image display portion 2221, and a time point is displayed at explanation display portion 2222.

Display interval selection portion 2207 for selecting an interval of a time point to be displayed in image-by-time list 2228 is provided on the whole-day checking screen.

Similar to the store comparison screen (see FIG. 22), sales-floor selection menu 2224 is displayed at selection menu display portion 2204 on the whole-day checking screen. If the user selects sales floor on the sales-floor selection menu 2224, the area image in image-by-time list 2228 is switched to the area image of the selected sales floor.

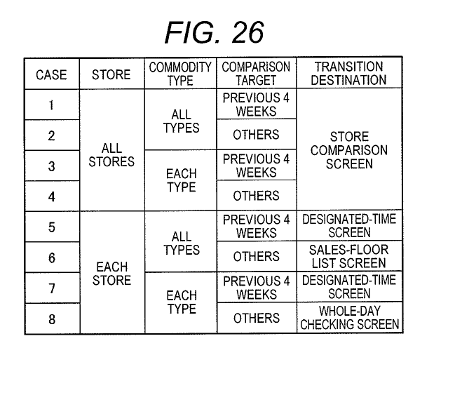

Next, a monitoring screen as a transition destination when button 2127 of “monitoring” has been operated on the daily graph analysis screen (see FIG. 18) will be described. FIG. 26 is a diagram illustrating the monitoring screen as a transition destination when button 2127 of “monitoring” has been operated.

If the user operates button 2127 of “monitoring” on the daily graph analysis screen (see FIG. 18), the screen is transitioned to the monitoring screen (store comparison screen, sales-floor list screen, designated-time screen, or whole-day checking screen). At this time, an item determined on the daily graph analysis screen is inherited to the monitoring screen as the transition destination. However, it is not possible that an item which is not determined on the daily graph analysis screen is inherited to the monitoring screen as the transition destination. Therefore, the monitoring screen as the transition destination varies depending on contents selected at store selection portion 2111, commodity type selection portion 2112, and comparison target selection portion 2133 in analysis condition designation portion 2122. The monitoring screen as the transition destination does not have a relationship with the content selected at analysis index selection portion 2113.

That is, in a case (Cases 1 to 4) where all stores have been selected at store selection portion 2111, the store is not determined. Thus, the screen is transitioned to the store comparison screen (see FIG. 22). At this time, in a case (Cases 1 and 2) where all types have been selected at commodity type selection portion 112, the sales floor is not determined. Thus, an image of a sales floor having a small sales-floor comparison ID is displayed. In a case (Cases 3 and 4) where any commodity type has been selected on commodity type selection portion 112, the sales floor is determined. Thus, an image of the sales floor is displayed.

In a case (Cases 5 to 8) where any store has been selected at store selection portion 2111, the store is determined. Thus, the screen can be transitioned to any of the sales-floor list screen (see FIG. 23), the designated-time screen (see FIG. 24), and the whole-day checking screen (see FIG. 25).

Here, in a case (Cases 5 and 7) where any store has been selected at store selection portion 2111, and the previous four weeks have been selected at comparison target selection portion 2133, each day in the previous four weeks is determined. Thus, the screen is transitioned to the designated-time screen (see FIG. 24). At this time, in a case (Case 5) where all types have been selected at commodity type selection portion 2112, a sales floor is not determined. Thus, an image of a sales floor having a small sales-floor comparison ID is displayed. In a case (Case 7) where any commodity type has been selected on commodity type selection portion 2112, the sales floor is determined. Thus, an image of the sales floor is displayed.

In a case (Cases 6 and 8) where any store has been selected at store selection portion 2111, and an item (no comparison target, all-store comparison, each store, or item addition) other than the previous four weeks has been selected at comparison target selection portion 2133, the monitoring screen as the transition destination varies depending on the content selected at commodity type selection portion 2112. That is, in a case (Case 6) where all types have been selected at commodity type selection portion 2112, a sales floor is not determined. Thus, the screen is transitioned to the sales-floor list screen (see FIG. 23). In a case (Case 8) where any commodity type has been selected on commodity type selection portion 2112, the sales floor is determined. Thus, the screen is transitioned to the whole-day checking screen (see FIG. 25).

The date and time (date and time point) designated on the daily graph analysis screen (see FIG. 18) is inherited on the store comparison screen (see FIG. 22) and the sales-floor list screen (see FIG. 23). In Case 5, the screen may be set to be transitioned to the sales-floor list screen (see FIG. 23).

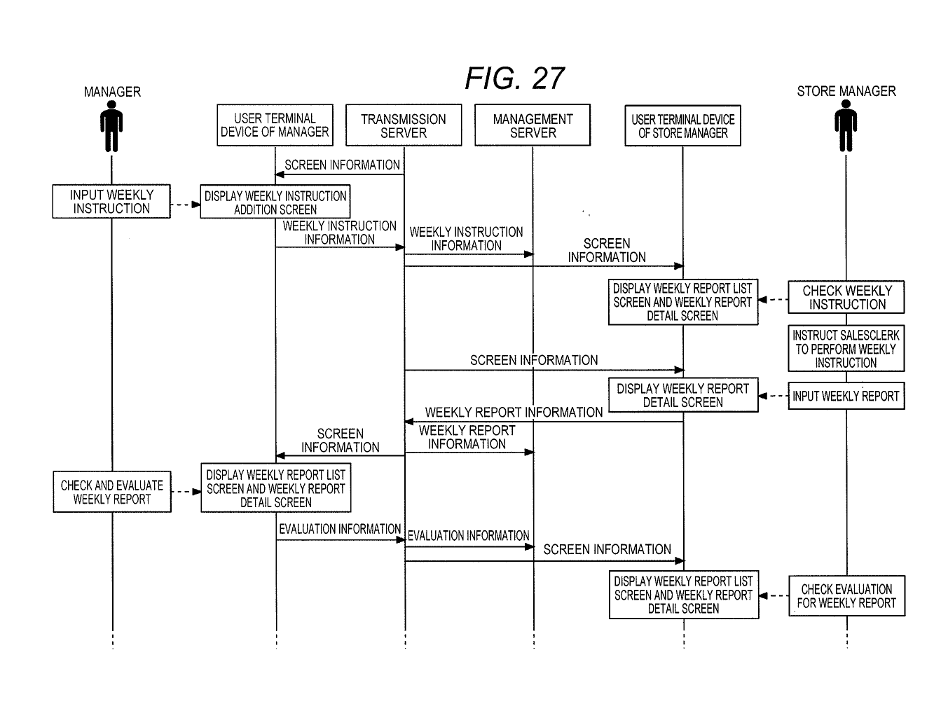

Next, a weekly instruction performed by the manager and a weekly report performed by the store manager in response to the weekly instruction will be described. FIG. 27 is a sequence chart illustrating an overall flow of a weekly instruction and a weekly report.

In the exemplary embodiment, a manager (first user) such as a supervisor who belongs to the headquarter that collectively controls each store and manages a plurality of stores, or an owner of multiple stores, who operates a plurality of stores, notifies a store manager (second user) of each store of a weekly instruction for a campaign or preparation of a sales floor, once a week.

If the store manager receives the weekly instruction from the manager, the store manager performs a work in the weekly instruction. If the work ends, the store manager submits a weekly report for a situation of performing the work of which the instruction has been received, to the manager. If the manager receives the weekly report from the store manager, the manager evaluates whether or not the work in the weekly instruction has been appropriately performed. If the work of which the instruction has been received has been appropriately performed, the manager approves the weekly report.

In a case where the work in the weekly instruction does not have been appropriately performed, the manager sends the weekly report back, and instructs the store manager to perform the work in the weekly instruction again. If the weekly report is sent back, the store manager performs the work in the weekly instruction again, and submits a weekly report to the manager again. The above transmission and reception repeat until the work in the weekly instruction is appropriately performed.

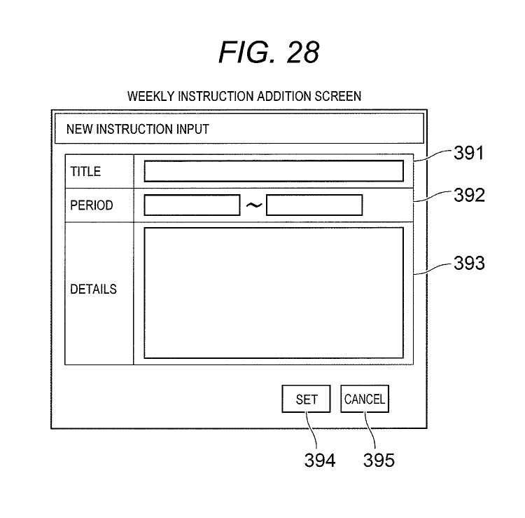

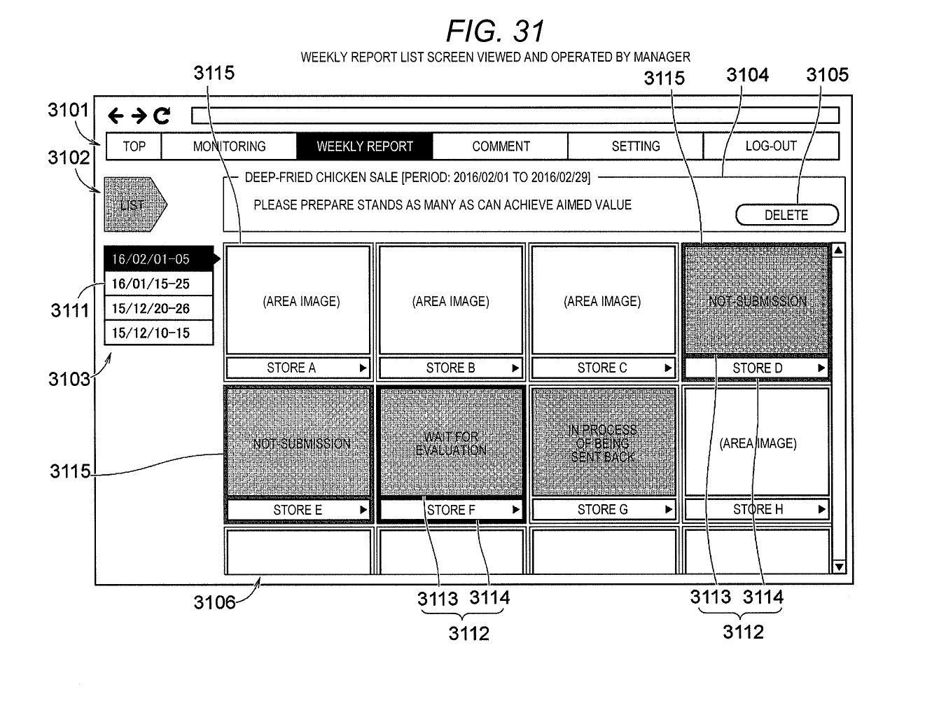

Specifically, firstly, the manager causes user terminal (PC) 6 to access transmission server 5 so as to display a weekly-instruction addition screen (first input screen, see FIG. 28). The manager inputs a new weekly instruction on the weekly-instruction addition screen. At this time, the manager may confirm that the new weekly instruction is correctly registered, by displaying a weekly-report list screen (browsing screen, see FIG. 31).

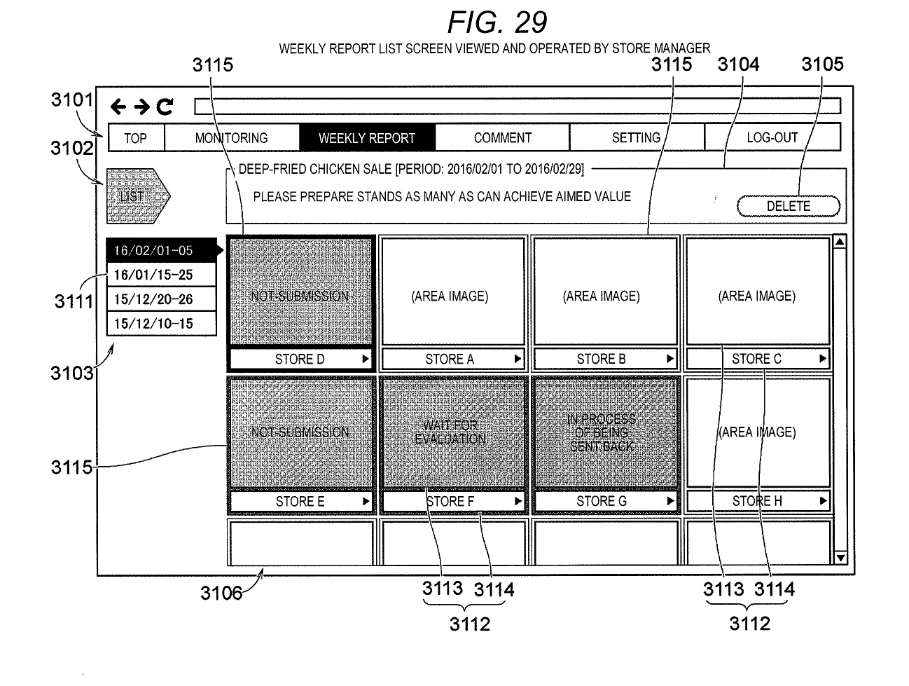

Then, the store manager causes user terminal (PC or smartphone) 6 to access transmission server 5 so as to display a weekly-report list screen (browsing screen, see FIG. 29). The store manager checks whether or not there is a new weekly instruction, on the weekly-report list screen. Here, in a case where there is the new weekly instruction, the store manager checks contents of the weekly instruction, and causes a salesclerk to perform a work in the weekly instruction.

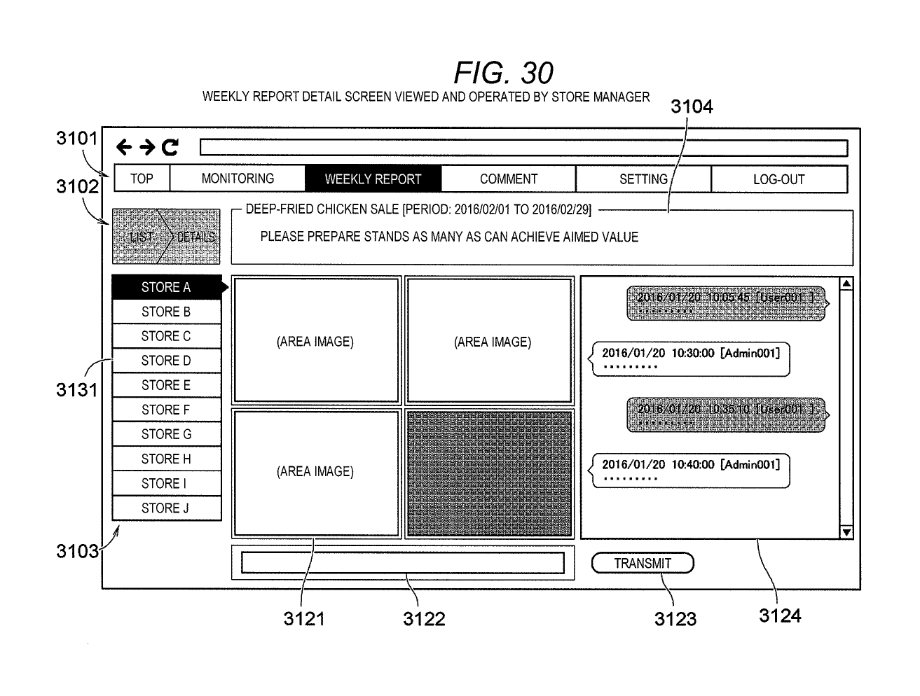

If the work in the weekly instruction ends, the store manager causes a target area in which the work has been performed to be imaged by a camera. The store manager causes user terminal (PC or smartphone) 6 to access transmission server 5 so as to display a weekly-report detail screen (second input screen, see FIG. 30). Then, the store manager inputs contents of a weekly report (report in response to the weekly instruction) for a result obtained by performing the work of which the instruction has been received. At this time, the store manager may display the weekly-report list screen (see FIG. 29) again so as to confirm that the weekly report is correctly registered.

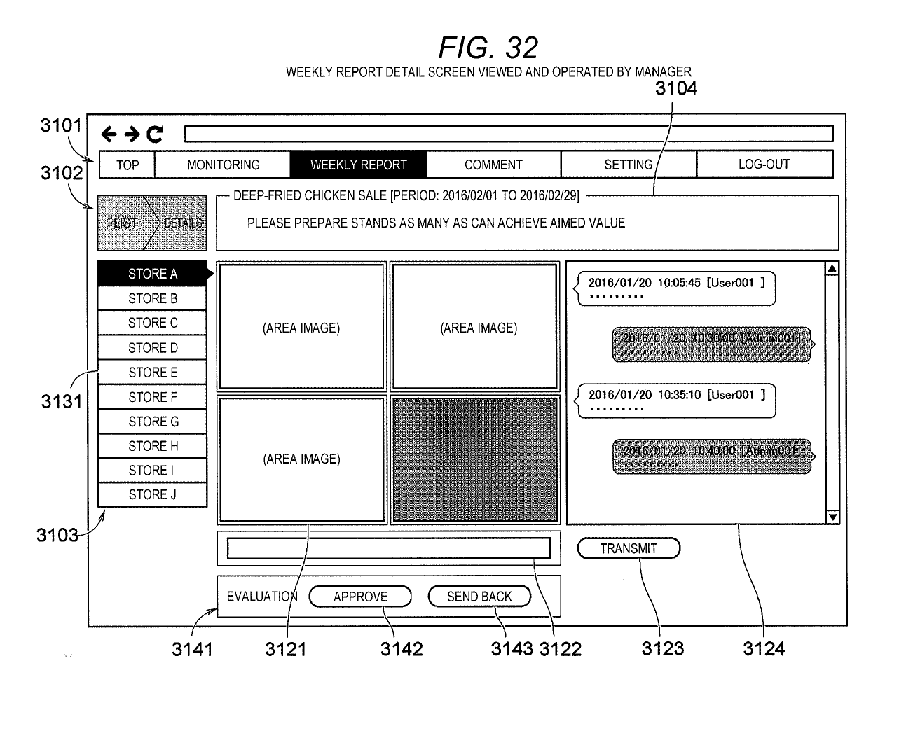

Then, the manager causes the user terminal (PC) 6 to access transmission server 5 so as to display a weekly-report list screen (browsing screen, see FIG. 31). The manager checks whether or not there is a new weekly report, on the weekly-report list screen. Here, in a case where there is the new weekly report, the manager causes a weekly-report detail screen (third input screen, see FIG. 32) to be displayed. The manager checks contents of the weekly report input by the store manager on the weekly-report detail screen, and evaluates a situation of performing the work of which the instruction has been performed. Here, in a case where the work of which the instruction has been performed, the manager performs an operation of approving the weekly report. In a case where the work of which the instruction has been performed is not appropriately performed, the manager performs an operation of sending the weekly report back. The manager inputs a comment for the evaluation. The above-described work as a target of the check and the evaluation of the weekly report is performed on all stores for each weekly instruction.

Then, the store manager causes user terminal (PC or smartphone) 6 to access transmission server 5 so as to display a weekly-report list screen (browsing screen, see FIG. 29). The store manager checks the evaluation for the weekly report which has been previously input, on the weekly-report list screen. If the weekly instruction is in a state of having been completed on the weekly-report list screen, the manager can evaluate that the work of which the instruction has been performed has been appropriately performed, and the store manager can grasp that the weekly report is approved.

If the weekly instruction is in a state of having been sent back on the weekly-report list screen, the manager can evaluate that the work of which the instruction has been performed does not have been appropriately performed, and the store manager can grasp that the weekly report has been sent back. In this case, the store manager causes a weekly-report detail screen (second input screen, see FIG. 30) to be displayed, and views the comment on the weekly-report detail screen, and thus checks deficiency in a task relating to the weekly instruction. The store manager instructs the salesclerk to perform the work in the weekly instruction again, so as to improve the deficiency.

As described above, in a case where the manager evaluates that the work of which the instruction has been performed does not have been appropriately performed, the store manager performs the work in the weekly instruction again and performs a weekly report again. In a case where the manager checks a weekly report input by the store manager, and the work of which the instruction has been performed does not have been appropriately performed, the manager sends the weekly report back. The above task repeats until the manager approves the weekly report.

Here, if the manager approves a weekly report input by the store manager, the weekly instruction relating to a target store turns to a completion state. However, at this time, the weekly report is transitioned to a shared state. In the shared state of the weekly report, the contents of the weekly report can be viewed by a store manager of another store, on the weekly-report list screen and the weekly-report detail screen. Thus, it is possible to share information regarding a specific situation in which the weekly instruction has been appropriately performed, between store managers.

The weekly report in which the weekly instruction is in the completion state may be set such that only viewing is possible, and edition is not possible. A deadline may be set in the weekly report. If the deadline elapses, the weekly report may be forcibly set to be in the completion state.

As described above, an input screen is transmitted from transmission server 5 to user terminal 6, and input information input on the input screen by the manager or the store manager is collected in transmission server 5. Specifically, instruction information regarding contents of an instruction, report information regarding a result obtained by performing a work of which an instruction has been performed, and evaluation information regarding an evaluation result for a situation of performing a work of which an instruction has been performed are collected in transmission server 5.

Management server 5 acquires the instruction information, the report information, and the evaluation information collected by transmission server 5, from transmission server 5. The management server manages status information regarding a progress status of a task relating to the instruction, based on the above information. The status information includes information regarding a state (completion state) in which a weekly instruction has been completed, a state (not-submission state) where a weekly report is not submitted at all, a state (evaluation wait state) where an evaluation on a weekly report is not performed, and a state (sent-back state) where a weekly report has been sent back.

Next, the weekly-instruction addition screen viewed and operated by the manager will be described. FIG. 28 is a diagram illustrating the weekly-instruction addition screen viewed and operated by the manager.

The weekly-instruction addition screen is displayed in user terminal 6 in a case where a user who performs log-in is a manager. With the weekly-instruction addition screen, the manager can additionally register a new weekly instruction.

Title input portion 391, period input portion 392, detail input portion 393, set button 394, and cancel button 395 are provided on the weekly-instruction addition screen. The manager inputs a title of a weekly instruction at title input portion 391. The manager inputs a start date and an end date in a period for performing a weekly instruction, at period input portion 392. In an initial state, the date of the day of the week as a reference of the next week is displayed as the start date, and the date after one week from the start date is displayed as the end date, at period input portion 392. The manager inputs a comment for explaining the specific contents of a weekly instruction, at detail input portion 393.

In the weekly instruction, all stores are set as a target. Thus, the common contents in all the stores are input to input items of the title, the period, and the contents. The title and the period are essential input items, but an input of the details can be omitted.

If set button 394 is operated in a state of inputting a title, a period, and a comment at title input portion 391, period input portion 392, and detail input portion 393, instruction information including the title, the period, and the comment which are contents of the weekly instruction is transmitted to transmission server 5. Then, the weekly-instruction addition screen is closed. If cancel button 395 is operated, the input contents are discarded, and the weekly-instruction addition screen is closed.

Here, the instruction information transmitted from user terminal 6 to transmission server 5 is transmitted from transmission server 5 to management server 4. In management server 4, a new weekly instruction is registered in status information regarding a progress status of a weekly instruction, based on the received instruction information.

Next, the weekly-report list screen viewed and operated by the store manager will be described. FIG. 29 is a diagram illustrating the weekly-report list screen viewed and operated by the store manager.

The weekly-report list screen is displayed in user terminal 6 in a case where a user who performs log-in is a store manager (person other than the manager). With the weekly-report list screen, the store manager can check a weekly instruction registered by the manager.

Main menu 3101, screen transition situation display portion 3102, selection menu display portion 3103, instruction detail display portion 3104, delete button 3105, and store list display portion 3106 are provided on the weekly-report list screen.

In main menu 3101, any of the top, monitoring, a weekly report, a comment, setting, and log-out is allowed to be selected by a selection operation (clicking or tapping).

If the top is selected in main menu 3101, the screen is transitioned to a store comparison screen (not illustrated) which is the top screen for the monitoring function. If the monitoring is selected in main menu 3101, the screen is transitioned to the store comparison screen as the top screen of the monitoring screen.

If user terminal 6 starts a Web browser to access transmission server 5, firstly, a log-in screen (not illustrated) is displayed in the user terminal. If a user name and a password are input on the log-in screen, and an attempt of user authentication succeeds, the screen is transitioned to the store comparison screen which is the top screen for the monitoring function.

The monitoring screen is provided for checking a situation of a sales floor in each day in each sales floor of each store. A store comparison screen, a sales-floor list checking screen, a designated-time checking screen, and a whole-day checking screen are provided on the monitoring screen. The store comparison screen is provided for performing comparison of a situation of the common sales floor between the stores, by using the common sales floor as a target. The sales-floor list checking screen is provided for checking the situation of each sales floor in the selected store. The designated-time checking screen is provided for performing comparison of a situation of the selected sales floor between days different from each other, by using the sales floor as a target. The whole-day checking screen is provided for checking the situation of the sales floor at each time of the whole day on the selected date. A plurality of area images extracted based on a display condition of each screen is displayed on the monitoring screen.

If the weekly report is selected in main menu 3101, a sub-menu for selecting any of a report list and an instruction addition is displayed. If the report list is selected in the sub-menu, the screen is transitioned to the weekly-report list screen (see FIG. 29). If the instruction addition is selected in the sub-menu, the screen is transitioned to the weekly-instruction addition screen (see FIG. 28). Only in a case where a user who performs log-in is a manager, the instruction addition can be selected in the sub-menu.

If the comment is selected in main menu 3101, a sub-menu is displayed. With a selection operation of the sub-menu, the screen is transitioned to a comment list screen (not illustrated) or a comment setting screen (not illustrated). The comment list screen (not illustrated) is used for displaying a list of a comment of which a designated person such as a store manager is notified at an appropriate timing by a manager. The comment setting screen (not illustrated) is used for inputting a new comment.

If the setting is selected in main menu 3101, a sub-menu is displayed. With a selection operation of the sub-menu, the screen is transitioned to a user setting screen (not illustrated), a topic setting screen (not illustrated), or a password change screen (not illustrated). The user setting screen (not illustrated) is used for designating various user setting items. The topic setting screen is used for inputting a topic of which store managers of all stores are notified at once by a manager.

If the log-out is selected in main menu 3101, the screen in the process of being displayed is closed, and the screen is brought back to a log-in screen (not illustrated).

The transition situation of the screen is displayed at screen transition situation display portion 3102. As illustrated in FIG. 29, a list icon is displayed in a state where the weekly-report list screen is being displayed.

Weekly instruction selection menu 3111 is displayed at selection menu display portion 3103. A registered weekly instruction is displayed in weekly instruction selection menu 3111. If any weekly instruction is selected, information regarding the selected weekly instruction is displayed at instruction detail display portion 3104 and store list display portion 3106. In the example illustrated in FIG. 29, the period of a weekly instruction is displayed. However, the title or the period of a weekly instruction, or both the title and the period of the weekly instruction may be displayed. An initial state of the weekly-report list screen is a state where the latest weekly instruction has been selected.

Contents of a weekly instruction input on weekly-instruction addition screen (see FIG. 28), that is, the title, the period, and the details are displayed at instruction detail display portion 3104.

Delete button 3105 is operated in a case where the manager deletes a weekly instruction. As illustrated in FIG. 29, in a case where a user who performs log-in is a store manager (person other than the manager), the delete button is in a state where an operation is not possible. Thus, it is not possible that the store manager deletes the weekly instruction.

Store display portions 3112 are provided to be arranged at store list display portion 3106. Area image display portion 3113 and store-name display portion 3114 are provided at each of store display portions 3112. At store display portion 3112, a store handled by the store manager is preferentially displayed, and other stores are displayed to be arranged in ascending order of a store ID.

An area image input on the weekly-report detail screen (see FIG. 30) by a store manager of each store is displayed at area image display portion 3113. In a case where the store manager inputs a plurality of area images, one of the plurality of area images is displayed.

Here, in the exemplary embodiment, an area image is displayed at area image display portion 3113 of a store in a state (completion state) where a weekly instruction has been completed. A text indicating the progress status of a weekly instruction is displayed at area image display portion 3113 of a store in a state where the weekly instruction is not completed, that is, a state (not-submission state) where a weekly report is not submitted at all, a state (evaluation wait state) where an evaluation for a weekly report is not performed, or a state (sent-back state) where a weekly report has been sent back, in accordance with the state.

Frame image 3115 indicating the progress status of a weekly instruction is displayed at store display portion 3112. Frame image 3115 expresses the progress status of a weekly instruction by changing a display form. Specifically, in a case where a task is provided for the viewer, frame image 3115 is displayed with a red color (first display form). In this case, red frame image 3115 is blink-displayed, in particular, such that the viewer can immediately pay attentions. In a case where a task is provided for a person other than the viewer, frame image 3115 is displayed with a yellow color (second display form). In a case where a task is provided for no one in a state where the weekly instruction has been completed, frame image 3115 is displayed with a white color (no-colored, third display form).

Here, FIG. 29 illustrates the weekly-report list screen viewed by a store manager. In a case where a weekly report in response to a new weekly instruction is not submitted at all for a store handled by the store manager, or in a case where the weekly report has been sent back, it is necessary that the store manager performs the weekly report. In such a case, since a task is provided for the store manager who is a viewer, red frame image 3115 for the store handled by the store manager is blink-displayed.

In a case where an evaluation (approval, sending-back) for a weekly report is not performed, it is necessary that the manager performs the evaluation. In such a case, since a task is provided for a person other than the store manager being a viewer, yellow frame image 3115 for the store handled by the store manager is displayed. If the weekly instruction is in a state of being completed, since a task is provided for no one, white frame image 3115 is displayed.

A situation of another store which is not handled by the store manager can also be viewed on the weekly-report list screen. In a case where a weekly report in response to a new weekly instruction is not submitted at all or in a case where the weekly report has been sent back, it is necessary that a store manager of another store performs the weekly report at area image display portion 3113 of another store. In addition, in a case where an evaluation for the weekly report is not performed, it is necessary that the manager performs the evaluation. In such a case, since a task is provided for a person other than the store manager being a viewer, yellow frame image 3115 is displayed at area image display portion 3113 of another store. Since a task is provided for no one in a store in a state where the weekly instruction has been completed, white frame image 3115 is displayed.

In the example illustrated in FIG. 29, store D handled by a store manager being a viewer is in a state (not-submission state) where a weekly report is not performed at all. Thus, a text of “not-submission” is displayed at area image display portion 3113 of store D, and red frame image 3115 is blink-displayed at store display portion 3112 of store D.

Store E is in a state (not-submission state) where a weekly report is not performed at all. Thus, a text of “not-submission” is displayed at area image display portion 3113 thereof. Store F is in a state (evaluation wait state) where an evaluation for a weekly report is not performed. A text of “wait for evaluation” is displayed at area image display portion 3113 thereof. Store G is in a state (sent-back state) where a weekly report has been sent back. A text of “process of being sent back” is displayed at area image display portion 3113 thereof. Yellow frame image 3115 is displayed at store display portions 3112 of stores E, F, and G. Another store is in a state where a weekly instruction has been completed. Thus, an area image thereof is displayed, and white frame image 3115 is displayed.

In a case where a task is provided for no one in a state where a weekly instruction has been completed, frame image 3115 may be set not to be displayed.

If store-name display portion 114 is operated, the screen is transitioned to the weekly-report detail screen (see FIG. 30). For example, if red frame image 3115 is blink-displayed at store display portion 3112 of a store handled by a store manager being a viewer, the store manager may operate store-name display portion 3114 of a store handled by the store manager and transition the screen to the weekly-report detail screen, in order to input a weekly report.

As described above, in the exemplary embodiment, with the weekly-report list screen, the store manager can be urged to perform a work of which an instruction has been performed and perform a weekly report, and the store manager can be urged to perform the work of which the instruction has been performed, again.

In the exemplary embodiment, in a state (not-completion state) where a weekly instruction is not completed, an area image is not displayed at area image display portion 3113, and a text (not-submission, wait for evaluation, process of being sent back) indicating the progress status of a weekly instruction is displayed at the area image display portion. However, in a case where a store manager inputs an area image, the area image may be displayed even in the not-completion state, and display of the text indicating the progress status of a weekly instruction may be omitted. In this case, with the display form of frame image 3115, it is possible that the user grasps the progress status of a weekly instruction.

In the above-described exemplary embodiment, the progress status of a weekly instruction is expressed with a display color of frame image 3115, that is, the display color of frame image 3115 varies depending on whether or not a task is provided for a viewer. However, the progress status of a weekly instruction may be expressed by changing a display element other than the display color, for example, the thickness or a type of a line, or a filling pattern.

Next, the weekly-report detail screen viewed and operated by the store manager will be described. FIG. 30 is a diagram illustrating the weekly-report detail screen viewed and operated by the store manager.

The weekly-report detail screen is displayed in user terminal 6 in a case where a user who performs log-in is a store manager (person other than the manager). The store manager can input the contents of a weekly report. The weekly report detail image is displayed by operating store-name display portion 3114 on the weekly-report list screen (see FIG. 29).

Main menu 3101, screen transition situation display portion 3102, selection menu display portion 3103, instruction detail display portion 3104, area image display-and-input portion 3121, comment input portion 3122, transmit button 3123, and comment display portion 3124 are provided on the weekly report detail image.

Main menu 3101 and instruction detail display portion 3104 are similar to those on the weekly-report list screen (see FIG. 29). As illustrated in FIG. 30, a list icon and a detail icon are displayed at screen transition situation display portion 3102, in a state of being transitioned to the weekly-report detail screen. If the list icon is selected, the screen is brought back to the weekly-report list screen (see FIG. 29).

Store selection menu 3131 is displayed at selection menu display portion 3103. If a store is selected in store selection menu 3131, information regarding selected store is displayed at area image display-and-input portion 3121 or comment display portion 3124. An initial state when the screen has been transitioned from the weekly-report list screen (see FIG. 29) is a state where a store has been selected on the weekly-report list screen. The store manager can view a weekly report for another store by selecting another store in store selection menu 3131.

The store manager inputs an area image obtained by capturing a situation of performing a weekly instruction, at area image display- and -input portion 3121. In the example illustrated in FIG. 30, area images can be input up to four. If an operation of selecting area image display-and-input portion 3121, an image selection screen (not illustrated) is displayed. An image file is read by selecting the image file of an area image on the image selection screen, and thus the area image is displayed at area image display-and-input portion 3121.

Here, the image file of the area image is obtained by capturing a target area such as a sales floor, with a camera held by the store manager. It is assumed that the image file of the area image is preserved in user terminal (PC) 6 in advance.

In the exemplary embodiment, an area image extracted from a captured image of camera 1 installed in a store may be accumulated in recording server 3. An access to recording server 3 may be performed to select the latest area image accumulated in recording server 3.

A comment of which the manager is notified is input at comment input portion 3122.

If transmit button 3123 is operated in a state where an area image has been input at area image display-and-input portion 3121 and a comment has been input at comment input portion 3122, report information including the area image and the comment which is contents of a weekly report is transmitted to transmission server 5. The report information is transmitted from transmission server 5 to management server 4. In management server 4, status information regarding the progress status of a weekly instruction is updated based on the received report information.

A comment which has been previously transmitted and received between the store manager and the manager is displayed at comment display portion 124. With comment display portion 124, the store manager can check a comment which has been transmitted and received in a state of relating to a target weekly instruction.

Next, the weekly-report list screen viewed and operated by the manager will be described. FIG. 31 is a diagram illustrating the weekly-report list screen viewed and operated by the manager.

The weekly-report list screen is displayed in user terminal 6 in a case where a user who performs log-in is a manager. With the weekly-report list screen, the manager can check a progress state of a weekly instruction registered by the manager, in each store.

The weekly-report list screen is substantially similar to the weekly-report list screen (see FIG. 29) viewed and operated by the store manager. However, this weekly-report list screen is different from the weekly-report list screen viewed and operated by the store manager in that delete button 3105 is allowed to be operated. Delete button 3105 is provided for deleting a registration of a weekly instruction in a case where the weekly instruction has been erroneously registered. If delete button 3105 is operated, a confirmation dialog for inquiring whether or not to delete the weekly instruction is displayed. Here, if an OK button is operated, registration information of the weekly instruction is deleted.

Similar to the weekly-report list screen (see FIG. 29) viewed and operated by the store manager, area image display portion 3113 and store-name display portion 3114 for each store are provided at store list display portion 3106. However, here, area image display portion 3113 and store-name display portion 3114 for each store are displayed to be arranged in ascending order of a store ID.

Similar to the weekly-report list screen (see FIG. 29) viewed and operated by the store manager, an area image is displayed at area image display portion 3113 of a store in a state (completion state) in which a weekly instruction has been completed, in store list display portion 3106. A text indicating the progress status of the weekly instruction is displayed at area image display portion 3113 of a store in a state where the weekly instruction has not been completed.

Similar to the weekly-report list screen (see FIG. 29) viewed and operated by the store manager, frame image 3115 is displayed at store display portion 3112 in store list display portion 3106. However, since a viewer is the manager, the display form of the frame image is different from that on the weekly-report list screen viewed and operated by the store manager, even though the progress status (not-submission state, evaluation wait state, or sent-back state) of the weekly instruction is identical to that.

That is, in a state (evaluation wait state) where an evaluation for a weekly report is not performed, it is necessary that the manager performs the evaluation, that is, a task is provided for the manager being a viewer. Thus, red frame image 3115 is blink-displayed at store display portion 3112 of the corresponding store. In a state (not-submission state) where a weekly report is not performed at all or a state (sent-back state) where a weekly report has been sent back, it is necessary that the store manager performs a weekly report, that is a task is provided for a person other than the manager being a viewer. Thus, yellow frame image 3115 is displayed. In a case where a task is provided for no one in a state (completion state) where a weekly instruction has been completed, white frame image 3115 is displayed. This is similar to the weekly-report list screen viewed and operated by the store manager.

In the example illustrated in FIG. 31, store F is in a state (evaluation wait state) where an evaluation for a weekly report is not performed. A text of “wait for evaluation” is displayed at area image display portion 3113. In addition, since a task is provided for the manager being a viewer, red frame image 3115 is blink-displayed at store display portion 3112.

Stores D and E are in a state (not-submission state) where a weekly report is not submitted at all, and a text of “not-submission” is displayed at area image display portion 3113. Store G is in a state (sent-back state) where a weekly report has been sent back, and a text of “process of being sent back” is displayed at area image display portion 3113. Yellow frame image 3115 is displayed at store display portions 3112 of stores D, E, and G. Another store is in a state where a weekly instruction has been completed. Thus, an area image thereof is displayed, and white frame image 3115 is displayed.

Next, the weekly-report detail screen viewed and operated by the manager will be described. FIG. 32 is a diagram illustrating the weekly-report detail screen viewed and operated by the manager.

The weekly-report detail screen is displayed in user terminal 6 in a case where a user who performs log-in is a manager. With the weekly-report detail screen, the manager can view a weekly report submitted by the store manager, and evaluate whether or not the weekly instruction has been appropriately performed.

The weekly-report detail screen is substantially similar to the weekly-report detail screen (see FIG. 30) viewed and operated by the store manager, but is different from the weekly-report detail screen viewed and operated by the store manager in that evaluation input portion 3141 is provided.

An area image input on the weekly-report detail screen (see FIG. 30) viewed and operated by the store manager, by the store manager is displayed at area image display-and-input portion 3121. Here, if the area image being displayed is selected, the enlarged area image is displayed, and thus, it is possible to check the actual situation in a target area (sales floor) in detail.

Approve button 3142 and send-back button 3143 are provided at evaluation input portion 3141. Approve button 3142 is provided for approving a weekly report in a case where a weekly instruction has been appropriately performed. Send-back button 3143 is provided for sending a weekly report back to the store manager in a case where a weekly instruction does not have been appropriately performed.

Here, if approve button 3142 or send-back button 3143 is operated, evaluation information regarding an approval or being sent back is transmitted to transmission server 5. The evaluation information is transmitted from transmission server 5 to management server 4. In management server 4, status information regarding the progress status of a weekly instruction is updated based on the received evaluation information. At this time, in a case where approve button 3142 is operated, the state (completion state) where a weekly instruction has been completed occurs. In a case where send-back button 3143 is operated, a state (sent-back state) where a weekly report has been sent back occurs.

Similar to the weekly-report detail screen (see FIG. 30) viewed and operated by the store manager, if a comment is input at comment input portion 3122, and transmit button 3123 is operated, the comment is transmitted to transmission server 5. Thus, only the comment can be transmitted and received to and from the store manager without performing an evaluation (approval or sent-back).

In the exemplary embodiment, transmit button 3123 for transmitting a comment is provided. However, if approve button 3142 or send-back button 3143 functions as transmit button 3123 together, that is, a comment is input at comment input portion 3122, and approve button 3142 or send-back button 3143 is operated, the comment may be transmitted along with evaluation information.

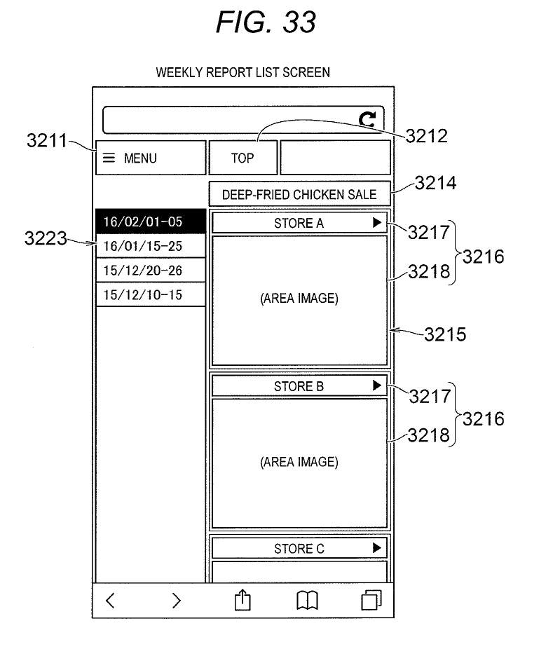

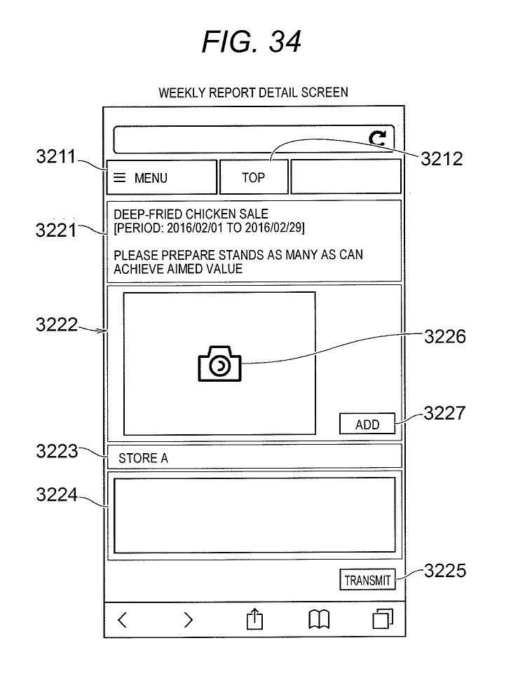

Next, a screen displayed in a smartphone as user terminal 6 will be described. FIG. 33 is a diagram illustrating the weekly-report list screen displayed in the smartphone. FIG. 34 is a diagram illustrating the weekly-report detail screen displayed in the smartphone.

FIGS. 29 and 30 illustrate the weekly-report list screen and the weekly-report detail screen displayed in a PC as user terminal 6. However, the store manager can use a smartphone as user terminal 6. In this case, the weekly-report list screen illustrated in FIG. 33 and the weekly-report detail screen illustrated in FIG. 34 are displayed in the smartphone as user terminal 6.

Main-menu display button 3211, top button 3212, weekly instruction selection menu 3213, weekly-instruction title display portion 3214, and store list display portion 3215 are provided on the weekly-report list screen illustrated in FIG. 33.

If main-menu display button 3211 is operated, a main menu similar to main menu 3101 on the weekly-report list screen (see FIG. 29) is displayed. If top button 3212 is operated, the screen is transitioned to the monitoring screen (not illustrated) as the top screen.

A registered weekly instruction is displayed at weekly instruction selection menu 3213. If any weekly instruction is selected, information regarding the selected weekly instruction is displayed at weekly-instruction title display portion 3214 and store list display portion 3215.

The title of a weekly instruction is displayed at weekly-instruction title display portion 3214.

Store display portions 3216 are provided side by side at the store list display portion 3215. Store-name display portion 3217 and area image display portion 3218 are provided at store display portion 3112.

Main-menu display button 3211, top button 3212, weekly instruction display portion 3221, area image display-and-input portion 3222, store-name display portion 3223, comment input portion 3224, and transmit button 3225 are provided on the weekly-report detail screen illustrated in FIG. 34.

Contents (title, period, and details) of a weekly instruction are displayed at weekly instruction display portion 3221.

An area image obtained by capturing a situation of performing a work of which an instruction has been performed is input at area image display-and-input portion 3222. Camera icon 3226 is displayed at area image display-and-input portion 3222 in a not-input state. If camera icon 3226 is operated, a menu for selecting any of camera capturing and an image selection is displayed.

Here, if camera capturing is selected, an application for causing a camera built in the smartphone to perform capturing starts, and thus the built-in camera can image a target area. An area image obtained by capturing the target area is displayed at area image display-and-input portion 3222. If image selection is selected, an image selection screen (not illustrated) is displayed. If an image file of an area image is selected on the image selection screen, the image file is read, and the area image is displayed at area image display-and-input portion 3222.

Add button 3227 is provided at area image display- and -input portion 3222. If add button 3227 is operated, an area image can be added.

The name of a store is displayed at store-name display portion 3223.

A comment of which the manager is to be notified is input at comment input portion 3224.

If transmit button 3225 is operated in a state where an area image has been input at area image display-and-input portion 3222 and a comment has been input at comment input portion 3224, report information including the area image and the comment which is contents of a weekly report is transmitted to transmission server 5.

Similar to the weekly-report detail screen (see FIG. 30) displayed in the PC as user terminal 6, a comment display portion for displaying a comment which has been previously transmitted and received between the store manager and the manager may be provided.

As described above, the exemplary embodiment has been described as an example of a technology disclosed in this application. However, the technology in the disclosure is not limited thereto, and can also be applied to embodiments in which change, substitution, addition, omission, and the like have been performed. A new exemplary embodiment can be made by combining the constituent components described in the above exemplary embodiment.

For example, in the above exemplary embodiment, an example of a retail store such as a convenience store is described. However, the exemplary embodiment can be widely applied to various facilities providing a product or a service to a user, for example, financial institutions such as banks and accommodations such as hotels.

In the above exemplary embodiment, cloud computer system 2 is independently configured with the three information processing apparatuses of recording server 3, management server 4, and transmission server 5. However, the functions of the servers may be realized by one information processing apparatus. Any two servers among the three servers may be configured by one information processing apparatus.

In the above exemplary embodiment, as illustrated in FIG. 2, an omnidirectional camera having a capturing range of 360 degrees with fish-eye lens is used as camera 1. However, a camera having a predetermined angle of view, that is, a so-called box camera may be used as camera 1.

In the above exemplary embodiment, various kinds of processing relating to the facility operation support are performed by cloud computer system 2 (recording server 3, management server 4, and transmission server 5). However, all or some of these kinds of processing may be performed by a PC installed in a store.

### INDUSTRIAL APPLICABILITY

The facility operation support device, the user terminal device, and the facility operation support method according to the disclosure present information required for improving the store operation to a user based on the image captured inside store, and thus have an advantageous effect that it is possible to reasonably perform a task for improving a store operation, and are useful as a facility operation support device, a user terminal device, a facility operation support method, and the like for supporting a task of a user who operates a facility providing a product to a user.

### REFERENCE MARKS IN THE DRAWINGS

1 CAMERA (FACILITY CAPTURING DEVICE)
2 CLOUD COMPUTER SYSTEM (FACILITY OPERATION SUPPORT DEVICE)
3 RECORDING SERVER (IMAGE ACCUMULATION UNIT, INFORMATION PROCESSING APPARATUS)
4 MANAGEMENT SERVER (INFORMATION PROCESSING APPARATUS)
5 TRANSMISSION SERVER (EVALUATION INFORMATION PRESENTATION UNIT, INFORMATION PROCESSING APPARATUS)
6 USER TERMINAL (USER TERMINAL DEVICE)
71 POLICY SETTING UNIT
72 IMAGE ACQUISITION UNIT
73 COMMODITY DETECTOR (PRODUCT DETECTOR)
74 POLICY EVALUATION UNIT
75 EVALUATION RESULT INTEGRATION UNIT
271 SALES INFORMATION ACQUISITION UNIT (ACCOUNTING INFORMATION ACQUISITION UNIT)
272 ANALYSIS CONDITION SETTING UNIT
273 EVALUATION UNIT
274 STATISTICAL INFORMATION GENERATION UNIT
275 IMAGE ACQUISITION UNIT

1. A facility operation support device that supports a task of a user who operates a facility providing a product to a user, the device comprising:
a policy setting unit that sets at least one policy in which an evaluation condition which includes an attention area and a display index in the facility and is used when a display state of a product is evaluated has been defined;
an image acquisition unit that acquires a captured image obtained by capturing the attention area;
a product detector that acquires product detection information indicating a position of a product in the attention area based on the captured image;
a policy evaluation unit that calculates an evaluation index corresponding to the display index, based on the product detection information, and evaluates an achievement situation of the policy based on the evaluation index; and
an evaluation information presentation unit that presents information regarding an evaluation result of each policy, which has been acquired by the policy evaluation unit, to the user.

2. The facility operation support device of claim 1,
wherein the display index is any one of a display quantity, a face-up degree, an alignment degree, a volume degree, and a stockout continuity degree, the display quantity indicating a degree of occupation of products in an area in which the products are displayed, the face-up degree indicating a degree of displaying products side by side at a frontmost position, the alignment degree indicating a degree of aligning and displaying products in a left-right direction, the volume degree indicating a degree of collectively displaying a large amount of products, and the stockout continuity degree indicating a degree of a length of a duration of a stockout state in which a product is short.

3. The facility operation support device of claim 1, further comprising:
an evaluation result integration unit that integrates the evaluation result of each policy acquired by the policy evaluation unit, in a unit of the facility, and acquires an evaluation score as the evaluation result in the unit of the facility,
wherein the evaluation information presentation unit presents the evaluation score relating to the facility attracting attentions to the user.

4. The facility operation support device of claim 1,
wherein the policy evaluation unit evaluates the achievement situation of the policy for each predetermined unit time, and
the evaluation information presentation unit presents digest information indicating a list of an evaluation result of the policy for each unit time, to the user.

5. The facility operation support device of claim 1,
wherein the evaluation information presentation unit presents the captured image obtained by capturing the attention area of each policy corresponding to the evaluation result, to the user, along with the evaluation result of each policy.

6. The facility operation support device of claim 5,
wherein the evaluation information presentation unit presents display information in which a frame image showing a range of the attention area is superimposed on the captured image obtained by capturing the attention area, to the user.

7. The facility operation support device of claim 1,
wherein the policy setting unit sets the policy, in which an evaluation time point has been defined, as the evaluation condition, and
the policy evaluation unit evaluates the achievement situation of the policy at the evaluation time point.

8. The facility operation support device of claim 1,
wherein the policy setting unit sets the policy, in which an evaluation criterion has been defined, as the evaluation condition, and
the policy evaluation unit evaluates the achievement situation of the policy based on the evaluation criterion.

9. The facility operation support device of claim 1,
wherein the policy setting unit sets the policy in which the evaluation condition has been defined, in accordance with an operation input of the user.

10. A user terminal device that displays a screen transmitted from the facility operation support device according to claim 1,
displays a screen for causing the user to designate at least one policy in which an evaluation condition which includes an attention area and a display index in the facility and is used when a display state of a product is evaluated has been defined, and
displays a screen for presenting information regarding a result obtained by evaluating an achievement situation of each policy based on the evaluation condition, to the user.

11. A facility operation support method of causing an information processing apparatus to support a task of a user who operates a facility providing a product to a user, the method comprising:
setting at least one policy in which an evaluation condition which includes an attention area and a display index in the facility and is used when a display state of a product is evaluated has been defined;
acquiring a captured image obtained by capturing the attention area;
acquiring product detection information indicating a position of a product in the attention area, based on the captured image;
calculating an evaluation index corresponding to the display index, based on the product detection information, and evaluating an achievement situation of the policy based on the evaluation index; and
presenting information regarding an obtained evaluation result of each policy to the user.

12. A facility operation support device that supports a task of a user who operates a facility providing a product or a service to a user, the device comprising:
an image accumulation unit that accumulates a plurality of area images obtained by capturing a target area in the facility;
an accounting information acquisition unit that acquires accounting information regarding providing of the product or the service to the user;
an evaluation unit that acquires an actual value and an expected value of each day in a target period based on the accounting information, compares the actual value and the expected value of each day to each other, evaluates a record for an operation situation of the facility for each day, and acquires a date to be an attention point, based on the evaluation result;
an image acquisition unit that acquires the area image corresponding to the attention point from the plurality of area images accumulated in the image accumulation unit; and
a display information generation unit that generates display information including a calendar, of the target period, on which the attention point has been shown and outputs display information including the area image corresponding to the attention point, in accordance with an operation of the user selecting the attention point.

13. The facility operation support device of claim 12,
wherein the image accumulation unit regularly acquires and accumulates the area image obtained by capturing the target area for each of a plurality of facilities.

14. The facility operation support device of claim 12,
wherein the accounting information acquisition unit acquires at least one of a sales amount, a payment amount per one user, the number of payers, and a proportion of a sales amount of each type of used product or service, as the accounting information.

15. The facility operation support device of claim 12, wherein the evaluation unit further comprises:
an expected-value setting unit sets at least one of a planned value of each facility, the actual value of each facility, an average value of the actual value for each of all the facilities, and an average value of the actual value on a plurality of designated dates in a predetermined period, as the expected value.

16. The facility operation support device according to claim 12,
wherein the display information generation unit outputs display information for performing a pop-up display of statistical information of a date corresponding to a selected cell, in accordance with an operation of the user who selects the cell for a date in the calendar.

17. The facility operation support device of claim 12, further comprising:
an analysis condition setting unit that sets at least one of the target period, a target facility, a target area in the facility, and a type of a target product or service, as an analysis condition, in accordance with an operation input of the user,
wherein the evaluation unit performs statistical processing on the accounting information based on the analysis condition, and acquires the actual value and the expected value on a date corresponding to the analysis condition.

18. The facility operation support device of claim 12,
wherein the display information generation unit outputs display information including a graph representing a transition situation of statistical information for each time slot, and outputs display information including the area image in a selected time slot, in accordance with an operation of the user who selects the time slot on the graph.

19. A user terminal device that displays a screen transmitted from the facility operation support device according to claim 12,
presents, to a user, a calendar of a target period, in which a date to be an attention point acquired by evaluating a record for an operation situation of the facility on each day in the target period is shown, based on accounting information for providing a product or a service to a user, and displays a screen for causing the user to select the attention point, and
displays a screen for presenting an area image in the facility corresponding to the attention point, to the user, in accordance with an operation of the user who selects the attention point.

20. A facility operation support method of causing an information processing apparatus to support a task of a user who operates a facility providing a product or a service to a user, the method comprising:
accumulating a plurality of area image obtained by capturing a target area in the facility;
acquiring accounting information for providing the product or the service to the user;
acquiring an actual value and an expected value on each day in a target period based on the accounting information, comparing the actual value and the expected value on each date to each other, evaluating a record for an operation situation of the facility on each day, and acquiring a date to be an attention point, based on the evaluation result;
acquiring the area image corresponding to the attention point from a plurality of accumulated area images; and
generating display information including a calendar, of the target period, on which the attention point has been shown, and outputting display information including the area image corresponding to the attention point, in accordance with an operation of the user who selects the attention point.

21.-31. (canceled)
